(19) United States
(12) Patent Application Publication
(10) Pub. No.: US 2017/0024672 A1
(43) Pub. Date: Jan. 26, 2017

(54) CREATING A MARKET GROWTH STRATEGY AND COMMERCIAL INVESTMENT ANALYSIS

(71) Applicant: Strategyn Holdings, LLC, San Francisco, CA (US)

(72) Inventors: Anthony W. Ulwick, Mill Valley, CA (US); Lance Bettencourt, Bloomington, IN (US); Richard Norman, Wilmington, NC (US); Urquhart Wood, Westerville, OH (US); James M. Haynes, III, San Francisco, CA (US)

(73) Assignee: Strategyn Holdings, LLC, San Francisco, CA (US)

(21) Appl. No.: 15/289,510

(22) Filed: Oct. 10, 2016

Related U.S. Application Data
(63) Continuation-in-part of application No. 14/553,757, filed on Nov. 25, 2014.
Application No. 14/553,757 is a division of application No. 14/183,019, filed on Feb. 18, 2014, now Pat. No. 8,924,244.
Application No. 14/183,019 is a continuation of application No. 13/533,845, filed on Jun. 26, 2012, now Pat. No. 8,655,704.
Application No. 13/533,845 is a division of application No. 12/476,160, filed on Jun. 1, 2009, now Pat. No. 8,214,244.
Application No. 12/476,160 is a continuation-in-part of application No. 12/253,433, filed on Oct. 17, 2008.
(60) Provisional application No. 61/057,806, filed on May 30, 2008.
(60) Provisional application No. 60/980,854, filed on Oct. 18, 2007.

(51) Int. Cl. G06Q 10/06; G06Q 40/06; G06Q 30/02

(52) U.S. Cl. CPC G06Q 10/06315; G06Q 30/0202; G06Q 40/06

(57) ABSTRACT

A technique for performing commercial venture analysis involves establishing an empirically-derived structure and evaluating companies using analytical techniques within that structure. The technique may involve defining jobs, or goals a customer is attempting to reach, with dozens or even hundreds of outcomes. Ideally, the structure and tools facilitate analysis that would not be possible otherwise. Moreover, the nature of the system enables real-time input for changing conditions and the ability to calculate returns for new markets in which products or services do not exist. A computer program product and business method is described for generating a market growth strategy. The computer program product in a computer-readable medium having instructions for directing a computer to focus on the core job that needs to be performed. A specific sequence is executed in several phases: market selection, target generation, business generation and portfolio generation strategies.

### CROSS-REFERENCE TO RELATED APPLICATIONS

This application is a continuation-in-part of U.S. patent application Ser. No. 12/253,433, filed on Oct. 17, 2008, which claims priority to U.S. Provisional Patent Application No. 60/980,854, filed on Oct. 18, 2007. Further, this application is a continuation-in-part of U.S. patent application Ser. No. 14/553,757, filed on Nov. 25, 2014, which is divisional of U.S. patent application Ser. No. 14/183,019, filed on Feb. 18, 2014, now U.S. Pat. No. 8,924,244, which is a continuation application of U.S. patent application Ser. No. 13/533,845, filed on Jun. 26, 2012, now U.S. Pat. No. 8,655,704, which is a divisional application of U.S. patent application Ser. No. 12/476,160, filed on Jun. 1, 2009, now U.S. Pat. No. 8,214,244, which claims priority to U.S. Provisional Patent Application No. 61/057,806, filed on May 30, 2008, The above mentioned patent applications are all hereby incorporated by reference.

### BACKGROUND

The computer program product allows the user to choose from a variety of missions. A mission is a particular task, project, or decision which an individual, employee, or business is contemplating. Upon selection of a specific mission, the data, including statements that define the criteria for creating value are retrieved from a database along with other pertinent facts that are critical to objective decision making. The user is then led through a process that enables the development of solutions and strategies that deliver many times more value than could normally be achieved.

It should also be noted that individuals and organizations often choose strategies that have worked for someone else. This approach is seldom successful as it ignores the desired outcomes that make that specific situation unique. The optimal strategy for a specific strategic situation is rarely a generic strategy as it is unlikely that the individuals involved, and their desired outcomes, are the same in any two strategic situations.

As the limitation of the human mind is well recognized, there is found in the prior art a number of methods and systems for designing, planning, manufacturing and evaluating the development of goods and services. However, none of these addresses nor solves the problems noted herein.

Almost all new products fail; in fact, according to Harvard Business Review, Jul. 1, 2004, 90% of all new products fail. This makes investment in early stage companies a gamble. Moreover, early-stage investment is highly inefficient because investment is diluted over time.

The foregoing examples of the related art and limitations related therewith are intended to be illustrative and not exclusive. Other limitations of the related art will become apparent upon a reading of the specification and a study of the drawings.

### SUMMARY

In various examples, one or more of the above-described problems have been reduced or eliminated, while other examples are directed to other improvements. The following examples and aspects thereof are described and illustrated in conjunction with systems, tools, and methods that are meant to be exemplary and illustrative, not limiting in scope.

A technique for performing commercial venture analysis involves establishing an empirically-derived structure and evaluating companies using analytical techniques within that structure. The technique may involve defining jobs, or goals a customer is attempting to reach, with dozens or even hundreds of outcomes. Ideally, the structure and tools facilitate analysis that would not be possible otherwise. Moreover, the nature of the system enables real-time input for changing conditions and the ability to calculate returns for new markets in which products or services do not exist.

### BRIEF DESCRIPTION OF THE DRAWINGS

FIG. 1 is a diagrammatic representation of the overall sequential process steps utilizing the methodology of the instant inventions.

FIG. 2 is a flowchart representing the generation of a targeting strategy 110 utilizing the methodology of the instant inventions.

FIG. 3 is a flowchart representing the generation of a business strategy 120 utilizing the methodology of the instant inventions.

FIG. 4 is a flowchart representing the generation of a portfolio product strategy 130 utilizing the methodology of the instant inventions.

FIG. 5 is a diagrammatic representation of platforms and potential options utilizing the methodology of the instant inventions.

FIG. 6 is a graphical representation of defined scores and outcomes for a first growth path.

FIG. 7 is an alternative graphical representation of defined scores and outcomes for a second growth path.

FIG. 8 is an alternative graphical representation of defined scores and outcomes for a new platform for a growth path.

FIG. 9 is an alternative graphical representation of defined scores and outcomes for a third growth path.

FIG. 10 is an alternative graphical representation of defined scores and outcomes for a new platform for a fourth growth path.

FIG. 11 is an alternative graphical representation of defined scores and outcomes for a new platform for a fourth growth path.

FIG. 12 is an alternative graphical representation of defined scores and outcomes for a new platform for a fourth growth path.

FIG. 13 depicts an example of a system for making investment decisions.

FIG. 14 depicts a flowchart of an example of a method for providing an investment decision.

FIG. 15 is intended to illustrate an example of a value add proposition for several outcome statements using techniques described with reference to FIGS. 13 and 14.

FIG. 16 depicts an example of a system for making investment decisions.

FIG. 17 depicts a flowchart of an example of a method for providing an investment decision.

FIG. 18 depicts an example of a platform data structure.

### DETAILED DESCRIPTION

It is important to note that these embodiments are only examples of the many advantageous uses of the innovative teachings herein. In general, unless otherwise indicated, singular elements may be in plural and vice versa with no loss of generality. In the drawings, like numerals refer to like parts through several views.

### User Input:

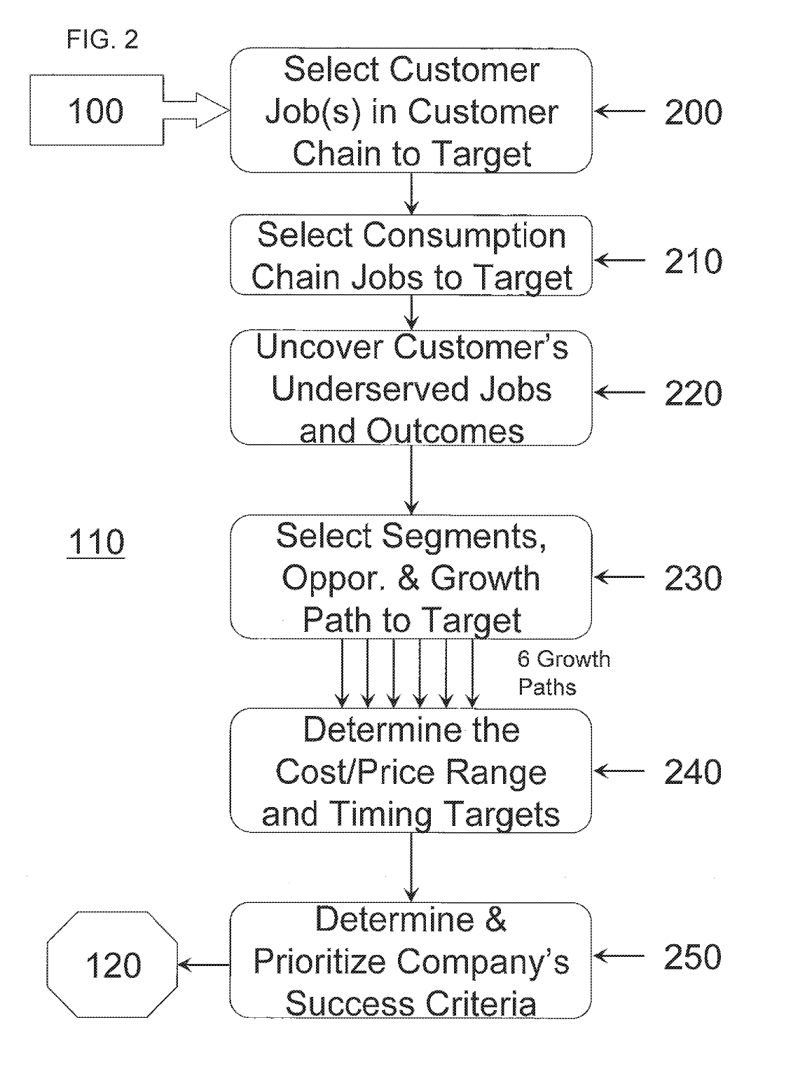

The following are different inputs that are listed below for consideration in association with FIG. 2 and other figures described in this paper.

### User Inputs for 200 Include

1. The set of customers in the customer chain, e.g., a raw material supplier, manufacturer, distributor, service provider (installer, maintainer, job executor, disposers), a user job executor).
2. The target audience (demographics of a population) within a customer set (e.g., chemist in for a raw material supplier, orthopedic surgeons, teens in the USA).
3. A situation or circumstance that the targeted audience experiences, e.g., chemist who work with hazardous materials, orthopedic surgeons who are inventors, teens while away from home.
4. The job(s) of focus that the target audience performs in that defined situation, e.g., the job of ensuring hazardous material does not contaminate ground water that chemists who work with hazardous materials perform, the job of commercializing an invention that orthopedic surgeon inventor perform, the job of staying in touch with friend that teens perform while away from home. These job(s) of focus that the target audience performs are referred to as the ‘core job(s)’.

The process prompts a user to provide importance and satisfaction scores for each of the customer sets in the customer chain for the job that they perform as inputs to the invention. The invention then determines which of these target audiences or ‘core jobs’ provides the best opportunity to create a market growth strategy.

### User Inputs for 210

For a selected customer set in the customer chain (e.g., the job executor), and the selected ‘core’ job that job executor performs, the process prompts a user to select consumption chain jobs related to executing the ‘core’ job that was selected. These selections are used as part of the input for 220.

### User Inputs for 220

The method prompts a user to input a list of jobs and outcome statements collected from the target audience in 200, the importance and satisfaction scores measured for the job and/or outcome statements, the number and a description of the people that provide the importance and satisfaction ratings for those statements, and the criteria that will be used to generate segments of respondents that have similar characteristics. These characteristics could be, but are not limited to demographic criteria, circumstances under which they perform a job, and/or a similar group of job and/outcome statements that are under or over served.

The computer will prioritize the job and outcome statements based on an opportunity score calculated from an opportunity algorithm to identify the most underserved job and/or outcomes. The invention process will also identify which of the job and/or outcome statements are overserved (importance score<satisfaction score) and appropriately served (importance=satisfaction score within experimental error of the importance and satisfaction score measurement). The invention will generate the opportunity scores for segments of the total population studied defined by the criteria provided by the user as well the size of those segments within the total population studied and a description of the type of respondent in each segment. The output of this step is used in 230.

### User Input for 230

In order to select the segments, opportunities and growth paths to target, the process requires the user to determine which jobs and outcomes are currently or can be impacted with the capabilities of value delivery platforms used by the job executor. Also, the user provides inputs on potential new job executors. These could be people that benefit from the core job being executed but do not execute the job themselves because they do not possess the skills, time or equipment needed to execute the job (a person who has their teeth whiten by a dentist), or people that are both the job executor and the job beneficiary that can now hire a service to perform the job for them (a homemaker that prepares a meal that now has a food service company prepare a meal for the home).

The method prompts the user to provide inputs of the selection criteria to determine if a segment of the market should be considered. For example, some, but not all, of the selection criteria may consist of a target number (e.g., a minimum number, the maximum number) of job and outcome statements that are underserved, a target number (e.g., a minimum number, the maximum number) of job or outcome statements that are overserved, a target number (e.g., a minimum number, the maximum number) of job and/or outcome statements that have an opportunity score above a threshold value (e.g., opportunity score≧10.0), a target number (e.g., a minimum number, the maximum number) of jobs/outcomes that have an importance score below a threshold value (e.g., importance score≦3.0), a target number (e.g., a minimum number, the maximum number) of job and outcome statement that both above a threshold value and unique to a segment, a demographic characteristic of the population (e.g., household incomes of $50,000 to $74,999), the size of a segment (e.g., 28% of the broad market), the profile the people that make up a segment (e.g., spends 10 hours/day or more away from the house).

The computer identifies the outcome statements that are both underserved and impacted by the current platform, which outcomes are both overserved and impacted by the current platform and which outcomes are both appropriately served and impacted by the current platform (Growth Path 1).

The computer identifies the job statements that are both underserved and impacted by the current platform, which jobs are both overserved and impacted by the current platform and which jobs are both appropriately served and impacted by the current platform (Growth Path 2).

The computer identifies the job statements that are both underserved and can not be impacted by the current platform, which jobs are both overserved and can not be impacted by the current platform and which jobs are both appropriately served and cannot impacted by the current platform (Growth Path 3).

The computer identifies the outcome statements that are both underserved and cannot be impacted by the current platform, which outcomes are both overserved and cannot be impacted by the current platform and which outcomes are both appropriately served and cannot impacted by the current platform (Growth Path 4).

The computer identifies which outcome statements are underserved and need a new platform that enables a new job executor to perform the job, which outcomes are overserved and need a new platform that enables a new job executor to perform the job, and which outcomes are appropriately served and need a new platform that enables a new job executor to perform the job, (Growth Path 5).

The computer identifies which job statements are underserved and need a new platform that enables a new job executor to perform the job, which jobs are overserved and need a new platform that enables a new job executor to perform the job, and which jobs are appropriately served and need a new platform that enables a new job executor to perform the job, (Growth Path 6).

The output of this step is inputted into 300 and/or 320.

### User Inputs for 240

The process prompts a user to input the time frame in which a concept created on the current platform or a new platform concepts need to be available to deliver to the market, the targeted cost goals to deliver the product/service, and the targeted price that market is expected to pay for the product/services delivered to the market in the specified timeframe. The output of this step is inputted in 330.

### User Input for 250

The method prompts a user to input a weighting for each company criteria and the threshold values that a concept should meet in order for the company to support the creation of a product or service concept. These inputs are provided for each platform that is currently used to support the product and/or services used by job executors performing the core job.

The computer uses these inputs to determine which of the company criteria are most and least important for a new product/service concept, new platform concept and/or new business model to meet in order for further development. The output of this step is used in Steps 300, 320 and 330.

### Inputs for 300

The process prompts the user to input ideas or features that address the jobs target for a new platform. The output of this step is used in steps 310 and 320.

### Inputs for 310

The method prompts the user to input ideas and/or concepts of how revenue could be potentially generated by the new platform as well as how fixed and/or variable cost can be potentially reduced in the new platform. The output of this step is used in Step 340.

### Inputs for 320

The method prompts the user to input the ideas that can be supported on a predefined platform that specifically address the outcomes targeted from the core job. The user's input identifies how each feature impacts the targeted outcomes and the degree to which that outcome is affected; This could be, but not necessarily be, an expected change in the satisfaction score of a job or outcome statement.

The computer identifies the targeted outcomes that have been negatively impacted by a feature or idea and randomly selects an innovation trigger for the user to consider for creating an idea or feature that would eliminate the negative impact on that outcome.

The computer identifies the targeted outcomes that have not been positively or negatively impacted by any feature or idea and randomly selects an innovation trigger for the user to consider for creating an idea that would positively impact that outcome.

### Input for 330

The method prompts the user to input the ability of a feature or platform idea to meet the threshold values for company criteria. The computer inputs a prioritized list of company success criteria with a set of threshold values and then identifies which of these features or platform ideas fail to meet one or more of the management criteria and selects an innovation trigger for the user to consider for creating or modifying a feature to improve its ability to meet a threshold value of one or more of the management's criteria. The output of this step goes to 320 to modify ideas or generate new platform ideas that will both address the unmet outcomes and the threshold values of the company successful criteria or to Step 340.

### Input for 340

The computer outputs from 330 and 310 are inputted along with an assessment from the user of the uniqueness of the enabling ideas for the platform, features on the platform and other processes generated. The output of 340 is a list to ideas and/or inventions that need to be protected from unlawful duplication or acquired for others.

### Market Growth Strategy Method:

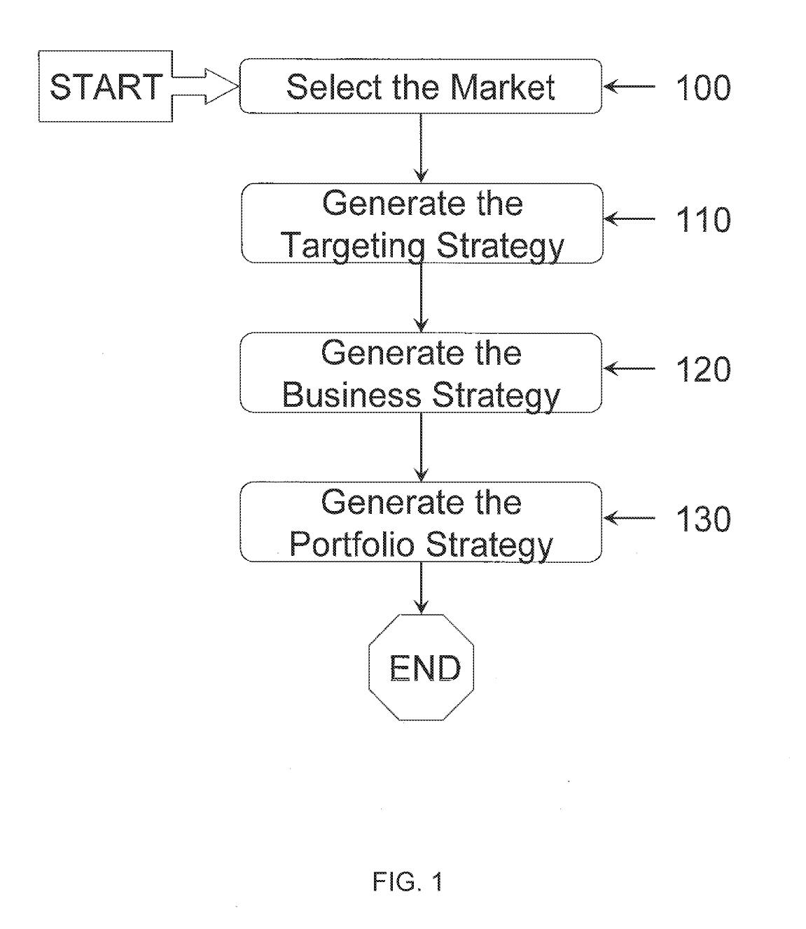

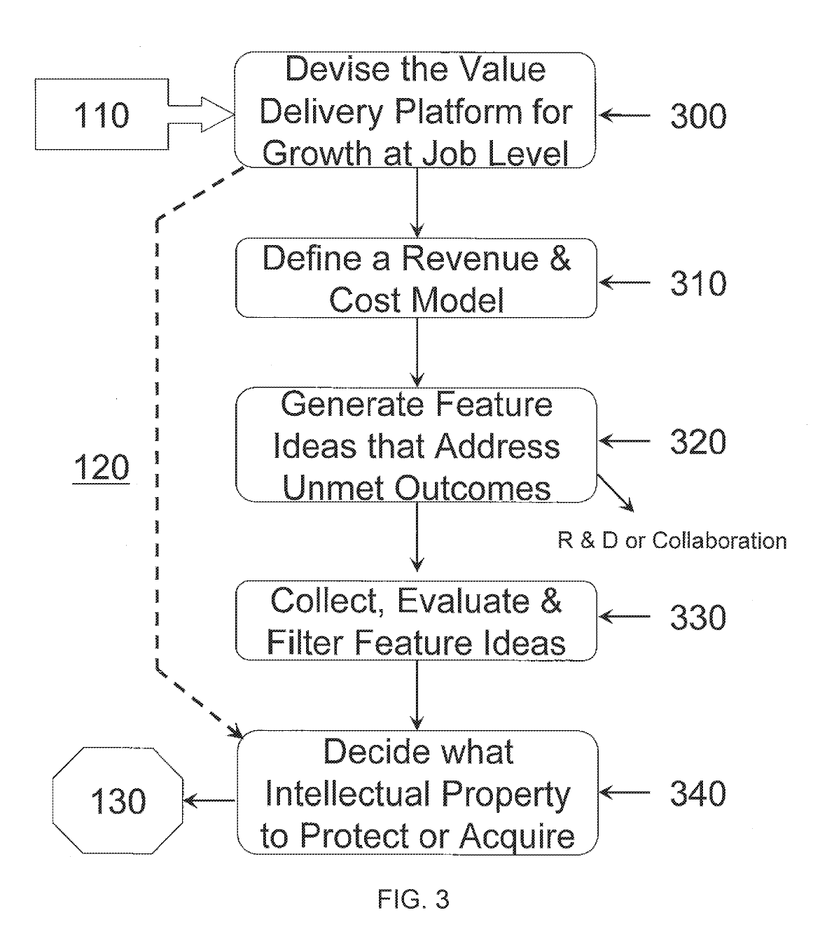

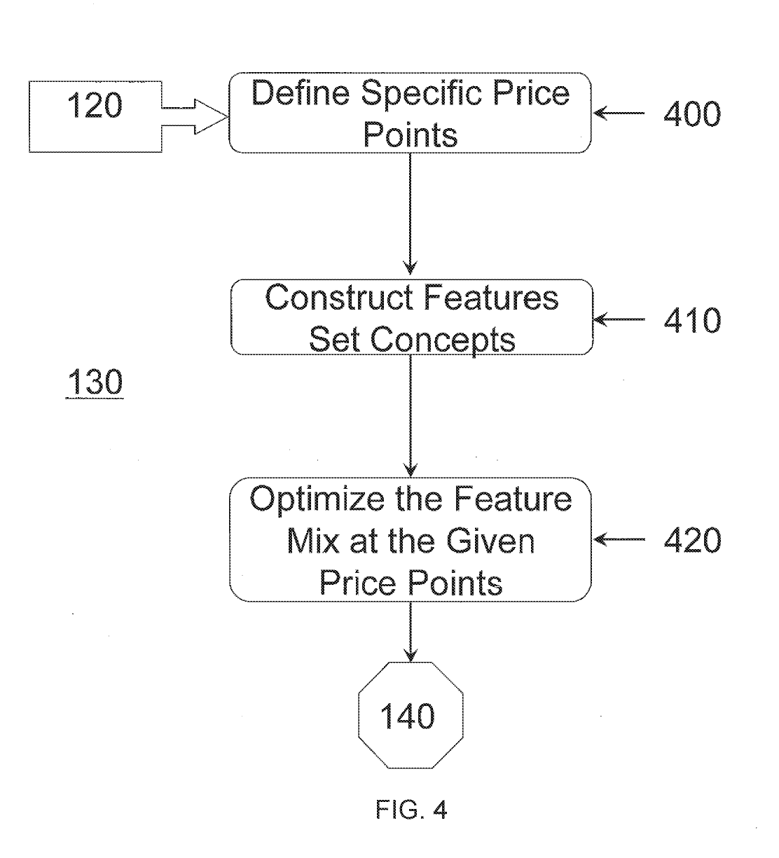

The method for creating a market growth strategy (see FIG. 1) comprises a series of sequential process steps executed in a specific order wherein the process steps are instructions stored, transferred or processed in a computer readable medium; an additional embodiment covers the business process method claims. The overall method as shown in FIG. 1 begins with the selection of the market 100. Then the process proceeds to generating a targeting strategy in step 110. The targeting strategy 110 generally involves selecting a job that is to be analyzed, uncovering and prioritizing the customer's unmet needs, devising a growth strategy (selecting a growth path) and prioritization of company criteria amongst other duties to be performed in this step. Next the business strategy is generated in step 120 that generally involves devising the delivery platform that is best, a business model and the feature set that can satisfy unmet outcomes and the filtering and protection of ideas amongst others. Finally the portfolio product strategy is generated in step 130; it is displayed, outputted to a file or printed out for easy review to one or more users. The process reaches its conclusion once the portfolio strategy has been generated. Steps 110-130 are further developed with connection to FIGS. 2-4 as described below. FIG. 2 is a flowchart representing the generation of a targeting strategy 110 utilizing the methodology of the instant invention. FIG. 3 is a flowchart representing the generation of a business strategy 120 utilizing the methodology of the instant invention. FIG. 4 is a flowchart representing the generation of a portfolio product strategy 130 utilizing the methodology of the instant invention. The entire process of generating a market growth strategy is summarized below in the proper sequence to achieve the aforementioned goals.
Select the market (FIG. 1, 100). Here, the process prompts a user representing a company to choose between a plurality of markets and determine which one(s) it wants to pursue. A market is defined here as a demographic and the job or jobs they are trying to get done. To make this decision, companies must evaluate each market in consideration against a set of company criteria, each of which must be agreed upon and prioritized by those making the decision. In most companies today, these criteria are not agreed upon, their priority is not agreed upon and the criteria that are used are not predictive of an attractive market. To overcome these issues, the invention provides the decision makers a fixed set of universal criteria that are accurate in determining which markets are most attractive for the company to pursue. To respond to some of the criteria, a minimal amount of secondary market research may be required. This is a computer implemented step associated with user inputs. The invention enables decision makers to evaluate said markets against the criteria using formulas that prioritize the markets based on their attractiveness to the company. The output of this step is the selection of one or more markets to pursue. For each market that is pursued, the subsequent steps are taken. In situations where a company is already in a market, this step may be skipped, as the goal would then be formulating a growth strategy for a market they are already in.
Select customer(s), job(s) in the customer chain to target (FIG. 2, 200). Here the process prompts the company or user to decide for whom it wants to create value. The primary target is always defined as the job executor—the person who performs the job that is being studied. Other customers may include the distributor, the purchase decision maker, the job beneficiary (the person or entity benefiting from the execution of the job) or others. The invention presents the user with a list of possible target customers with instructions on when and why to select each.
Select consumption chain jobs to target (FIG. 2, 210). Here the process prompts the company or user to decide which (if any) of the consumption chain jobs it wants to consider as a possible target for value creation. When a product or service is acquired to get a job done, customers must also consider a number of other jobs—for example, they may be forced to purchase, receive, install, set up, learn to use, interface with, transport, store, maintain, upgrade, replace and dispose of the product as well. These are called consumption chain jobs. The consumption chain jobs that are important to customers and poorly satisfied make good additional targets for value creation. The invention presents the user with a list of possible target consumption chain jobs with instructions on when and why to select each. The information needed to make the decisions must be collected from customers.
Uncover the customer's underserved jobs and outcomes (FIG. 2, 220). Here the process prompts the company or user to deconstruct the job that each target customer (job executor, distributor, etc.) is trying to get done into its discreet process steps and determine how that target customer measures the successful execution of each process step in that job. The metrics uncovered for each process step are the customer's needs. This same task is also executed for each consumption chain job that is targeted for value creation. The invention provides the user with a template to deconstruct each job. The template (a universal job map) contains and sequences the steps in which a job should optimally be executed. For the consumption chain jobs (which are universal across all products and services) the job map and needs are provided to the user as part of the invention. For the job being executed by the job executor, the metrics must be captured from customers using qualitative research methods designed for this purpose.
Select segments, opportunities and growth paths to target (FIG. 2, 230). For each job that is targeted, the process must determine which of the customer needs are unmet, where unmet is defined here as both important and unsatisfied. This determination is made using quantitative research methods designed for this purpose. The purpose of this step is to uncover opportunities for market growth. This may require segmentation analysis which is designed to uncover a segment of the overall population that has unmet (or a unique set) of unmet needs. Once all the opportunities (unmet needs) are uncovered, this information is used to formulate a market growth strategy. As part of this invention, it has been discovered that only six market growth paths exist. It has also been discovered that the growth path(s) that a company should pursue are dictated by what opportunities exist in the market. As a result, the data that has been collected when organized in this format prescribes the most effective market growth path(s) to take. Whereby in the past this decision was made poorly and with little information, the invention enables the user to quickly and accurately determine which path(s) to follow. With the growth path(s) selected, it becomes clear what unmet needs to focus on. The output of this step is used as an input into the idea generation process.
Determine the cost/price range and timing targets (FIG. 2, 240). Before idea generation can commence, company managers are prompted by the process to decide the time frame in which the to-be-generated product or service concept is required. In response to a competitive attack, for example, the time frame may be set at six months. In other situations a 2 year time frame may be acceptable. The invention requires that this input be entered into the process at this time, a practice that is not common or followed in a commonly executed in a process for market growth. Other factors that may impact timing that are considered as part of the invention include:
   Recent introduction of competitive offerings
   Planned introduction of competitive offerings
   Rate of decrease in market share
   Rate of decrease in revenue
   Obsolescence of current products
   Seasonal/cyclical purchase opportunities
   Investor expectations
   Desire to be first to market to address opportunities
In addition, at this point in the process the cost/price range for the to-be-generated product or service concept must also be entered into the process—again atypical to most processes and a step that is often poorly executed. As part of the invention, the user is presented with a cost/price algorithm that enables the company to accurately set a cost/price target. Secondary research may be required to obtain the data needed to execute this algorithm. The cost/price algorithm is listed in Appendix 1.
Determine and prioritize the company's success criteria (FIG. 2, 250). The process prompts company managers to decide what product platforms to fund, what business models to employ and what features to include on the company's products. To make these decisions, managers must agree on what criteria to use and the priority order of those criteria. The invention makes available a unique set of criteria required to effectively make these decisions. The criteria are universal across all companies and situations.

FIG. 3 has a DOTTED LINE from step 300 to step 340 where the process directs a user to protect the intellectual property that is created at the product platform level to be protected by a firm's intellectual property lawyers.

FIG. 3 has a R&D Collaboration line at step 320 where the process prompts a user or company to decide whether the people chosen to participate in the idea generation session will be internal company employees or people external to the company, e.g., customers, suppliers, specialists, etc.
Devise the value delivery platform for growth (FIG. 3, 300). Here, all the information collected and organized in the previous steps is presented by the method to those who are chosen to participate in platform-level idea generation, along with other information including (1) context around the customer need, (2) technical inputs as to why a need has not been addressed in the past and (3) insight into what intellectual property exists in this area of interest. Collectively, this information is organized and presented to idea generation participants as part of the invention. Participants use the inputs to guide their idea generation efforts and forms are presented to the user as part of the invention to capture the information that is needed to define and evaluate the alternative platform-level concepts. Concept evaluations are made by systematically evaluating a concept against all customer needs. Proprietary platform-level creativity triggers are also presented to the participants as part of the invention to help stimulate the generation of ideas.
Define a revenue and cost model (FIG. 3, 310). Here, the information collected in the previous steps is used by the process to drive the creation of a revenue and cost model (business model). As part of the invention, the idea generation participants are presented with needed information and a set of proprietary creativity triggers that direct the creation of profitable business models. Forms are presented to the user as part of the invention to capture the information that is needed to define and evaluate the alternative business model concepts. Concept evaluations are made by systematically evaluating a concept against all the company criteria previously collected from and prioritized by management.
Generate ideas that address the unmet outcomes (FIG. 3, 320). With an approved product platform and business model, idea generation participants are now guided by the method to fine-tune the product concept with the creation of a feature set that will be certain to address the customer's specific unmet needs (desired outcomes). Here, all the information collected and organized in the previous steps is presented to those who are chosen to participate in feature-level idea generation, including feature ideas that were generated during the platform-level idea generation session. Here again, as part of the invention, participants use the inputs to guide their idea generation efforts and forms are presented to the user as part of the invention to capture the information that is needed to define and evaluate the alternative feature-level concepts. Concept evaluations are made by systematically evaluating a feature concept against all related customer needs. Proprietary feature-level creativity triggers are also presented to the participants as part of the invention to help stimulate the generation of ideas.
Collect, evaluate and filter feature ideas (FIG. 3, 330). Once a product concept is defined, ongoing effort will be made to make product improvements. Here, new feature ideas will be solicited, documented and stored on a continuous and ongoing basis so that product improvement ideas are always available to the product management team.
Decide what intellectual property to protect or acquire (FIG. 3, 340). Here the process prompts a user to select what intellectual property that is created at the product feature level is to be protected by a firm's intellectual property lawyers. The form provided as part of the invention ensures the detail required for an effective filing is included as part of the idea submission.
Define specific price points (FIG. 4, 400). Here, the process prompts product managers to decide the number of product models that are needed and at what price points given the features concepts that have been generated.
Construct features set concepts) (FIG. 4, 410). Here, feature set concepts are optimized around different price points using an algorithm included as part of the invention. The algorithm considers the overall amount of value (need satisfaction) that is generated combining different features.
Optimize the feature mix at the given price point (FIG. 4, 4220). Here, those feature set concepts that that deliver the most value at the selected price points will result from executing the algorithm.

Steps 2-7 (FIG. 2, 200-250) generate the targeting strategy, steps 8-12 (FIG. 3, 300-340) generate the business strategy, and steps 13-15 (FIG. 4, 400-420) generate the portfolio strategy. The information needed for the business case supporting the strategy is collected in each of these steps. Executing the process in this order enables the correct actions to be taken at the right time and eliminates downstream actions from occurring without the needed inputs and decisions. This eliminates the need to for multiple iterations of steps in the process due to incorrect or missing input information. The inputs into each of these process steps include customer inputs, company inputs and societal inputs. The output of the process is a set of product and/or service concepts that will create value for the customer, company and society.

What has been discovered is that there exists, for each of the three constituents: the customer, the company and society, a specific set of process inputs that must be used to ensure the optimal results are achieved. These inputs, which are used to create and evaluate an effective market growth strategy, are the customer's desired outcomes (the metrics customers use to measure success when getting a job done), company success criteria (the metrics and specifications the company uses to judge the attractiveness of a value delivery platform, business model, feature idea and product and service concepts), and societal preservation criteria (the metrics society uses to judge the value of a product or service concept). These three types of inputs are always needed when formulating a market growth strategy, regardless of the industry, company and market under consideration.

### The Process Inputs

The company success criteria consist of a universal set of metrics that a company uses to determine what markets should be targeted for growth, which value delivery platforms to pursue, which business models to employ, what price point should be targeted, which product and service ideas and concepts are best as well as the company success criteria needed to transform a concept into the desire product and/or service. This finite set of metrics includes measures of financial, organizational, and technical feasibility. The company success criteria are included to shape the definition of the concept eliminating the need to redefine a concept during the development process.

As part of this market growth strategy process, the company's decision makers prioritize these universal metrics and then their organization applies them to the appropriate steps in the formulating a market growth strategy process. These metrics are used as inputs to the following steps:
Select the market (FIG. 1, 100)
Select customer(s), job(s) in the customer chain to target (FIG. 2, 200)
Select consumption chain jobs to target (FIG. 2, 210)
Select segments, opportunities and growth paths to target (FIG. 2, 230)
Determine the cost/price range and timing targets (FIG. 2, 240)
Devise the value delivery platform for growth (FIG. 3, 300)
Define a revenue and cost model (FIG. 3, 310)
Collect, evaluate and filter feature ideas (FIG. 3, 330)
Define specific price points (FIG. 4, 400)
Optimize the feature mix at the given price point (FIG. 4, 420)

The customer's acceptance criteria consist of a universal set of metrics that the customer to determine if they will accept the product/service for us. These customer criteria are related to obtaining a product or service, the financial implications of buying it, the performance issues related to using it, learning how to use it, customizing it, installing it, maintaining it, storing it and disposing of it. These customer criteria are prioritized by the targeted constituent and are used as inputs to the following steps:
Uncover the customer's underserved jobs and outcomes (FIG. 2, 220)
Generate ideas that address the unmet outcomes (FIG. 3, 320)
Collect, evaluate and filter feature ideas (FIG. 3, 330)

The societal preservation criteria consist of a universal set of metrics that are used to determine what benefits and cost the market growth strategy will have on society. For example these criteria are related to the benefits and costs a value delivery platform has on the environment or to a potential health risk and subsequent healthcare cost to society. These metrics are rated by the general public and the targeted customers and are used to understand how the ideas and concepts generated for the growth strategy align or conflict with the general public's, targeted customers' and the company's position on the impact of the market growth strategy will have on society. These society criteria are used as inputs to the following steps:
Select the market (FIG. 1,100)
Devise the value delivery platform for growth (FIG. 3, 300)
Define a revenue and cost model (FIG. 3, 310)
Collect, evaluate and filter feature ideas (FIG. 3, 330)

In addition, another set of criteria is used as inputs into the market growth strategy that are specific to the growth target. These inputs are the jobs and the desired outcomes of a specific job for the targeted customer set. In this context, a job is defined as the fundamental goals customers are trying to accomplish or problems they are trying to solve in a given situation. (Harvard Business School professor Clayton Christensen backs this thinking in The Innovator's Solution). When the customer performs the job themselves they are referred to as the job executor, when the customer receives the benefits from a job, but they do not perform the job themselves, then they are referred to as the job beneficiary. The job is the unit of analysis from which the market growth strategy will be created and not the customer (doctors), the product category (stents) or other traditional market definition (medical device industry). The desired outcomes of a job are the metrics that the job executor and/or beneficiary use to determine the successful execution of the job. These metrics reflect the speed, precision and output that define that job. The customer's importance and satisfaction ratings of the desired outcomes of the core job as well as those of other jobs that are related to the core job are used as input for formulating a market growth strategy. These jobs and outcomes are used as inputs to the following steps:
Select which unmet needs to target (FIG. 2, 230)
Generate ideas that address unmet needs/criteria (FIG. 3, 320)
Collect and evaluate idea (FIG. 3, 330)
Decide what intellectual property to protect (FIG. 3, 340)
Optimize feature set for a given price point (FIG. 4, 420)
Select which concepts to pursue overtime (FIG. 3, 330)

One unique aspect of this process is that these metrics provide all the people participating in creating and executing the market growth strategy the knowledge of the criteria from which the market growth strategy will be judged on to gain the support from the constituents that have a vested interested in the successful execution of the strategy. This information is known prior to formulating the strategy, thus lowering the probability of rejection from company decision makers, the market or society in general and eliminates to time and cost wasted on multiple iterations.

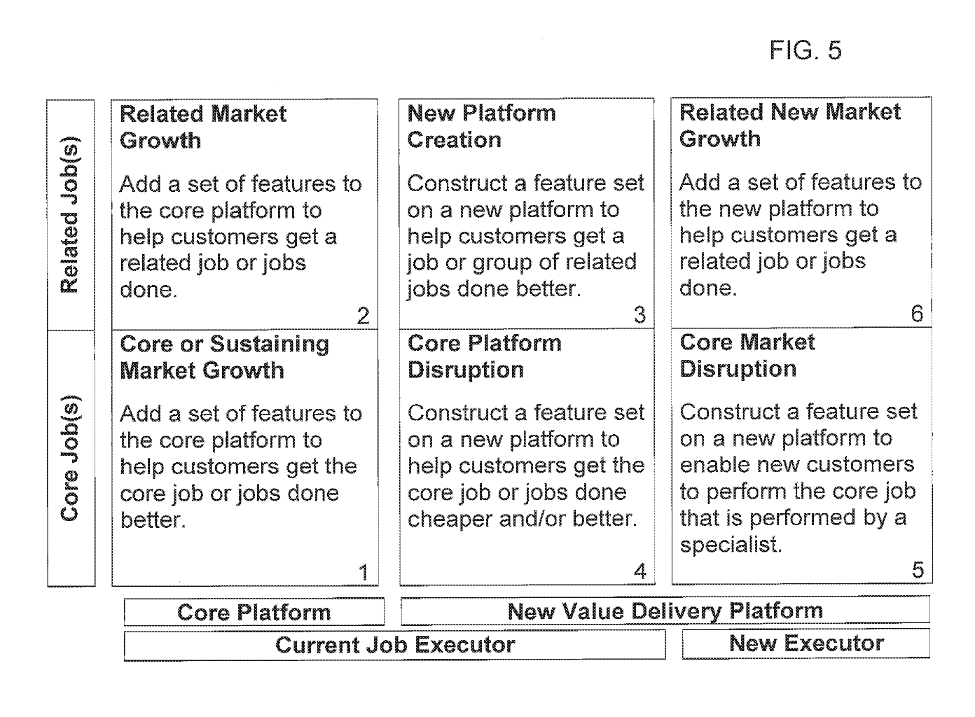

Another unique aspect of using these metrics is it makes it possible to classify the market growth strategy along 6 and only 6 potential growth paths. A value delivery platform along with a preliminary business model enables the opportunities to be satisfied along each of the growth paths. These growth paths are defined along three (3) dimensions that are shown in the vertical and horizontal perimeter of FIG. 5. These three dimensions are defined as follows:
The customer (Job executor or New executor)
The jobs that job executors perform (Core job or Related other jobs)
The value delivery platforms that enable the job executor to perform a job (Core platform or New value delivery platform)

Evaluating these three dimensions in their current (or core) state as well as in a new (or other) state creates six (6) and only six potential options to build a growth strategy around (FIG. 5). These six options are:
1. Core or Sustaining Market Growth—This growth path adds features to the core platform currently offered by the company to help customers (current job executors) get core job(s) done or that job(s) done better. By using the core platform the existing business model can be applied.
2. Related Market Growth—This growth path adds features to the current or core platform to help customers (current job executors) get other jobs related to the core job(s) done in addition to the core job(s). By using the core platform the existing business model can be applied.
3. New Platform Creation—This growth path constructs a feature set on a new platform offered by the company to help customers (current job executors) get a group of related jobs to the core job(s) done better. This new platform would enable the company to leverage a premium-price, high margin business model.
4. Core Platform Disruption—This growth path constructs a feature set on a new platform to help customers (current job executors) get the core job(s) done cheaper and/or better than with the core platform. This platform would may the company to leverage lower platform costs and/or a discounted or premium priced driven business model.
5. Core Market Disruption—This growth path constructs a feature set on a new platform to enable new customers (new job executors) perform the core job(s) currently performed by a specialist. This platform would enable the company to leverage lower-cost, premium-priced business model.
6. Related Market Growth—This growth path adds features to the new platform to help customers (new job executors) get a group of related jobs to the core job(s) done. This platform would enable the company to leverage lower-cost, premium-priced business model.

### Importance and Satisfaction Scores

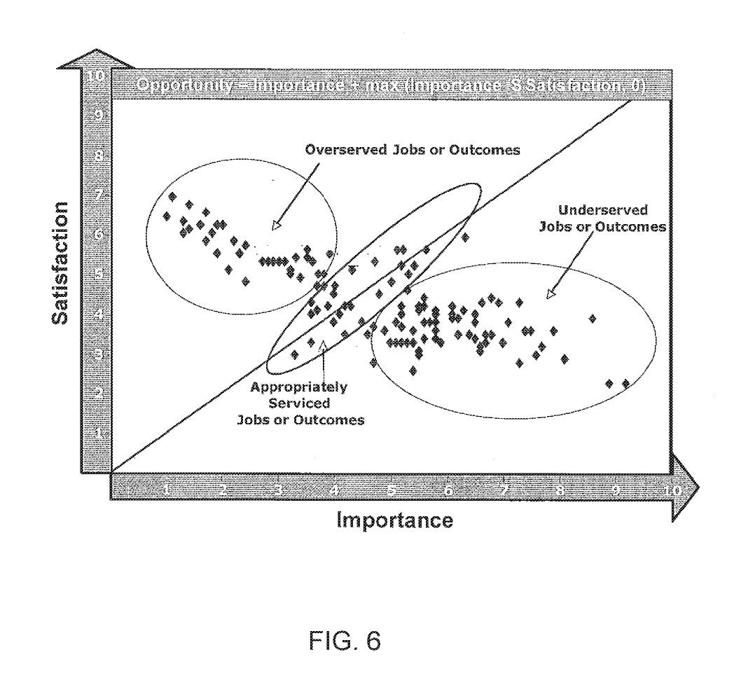

The computer program product on the computer readable medium of this invention utilizes a set of importance and satisfaction scores to determine the successful outcome of a core or related job(s). It should be noted that all individuals involved in a given process share a common set of desired outcomes. What differs from one individual to another is the importance they place on each desired outcome, and the degree to which they perceive each outcome is satisfied with respect to a given process. Therefore, the invention manipulates this information by quantifying which desired outcomes are most important or least important or anywhere between theses extremes to a given individual, a group of individuals with common interests, or the population in general. Value is created by improving an individual's or group's perceived level of satisfaction on one or more desired outcomes based on particular solutions offered to the individual or group. These importance and satisfaction scores are shown with reference to FIGS. 6-12.

In this method, a distribution set of importance and satisfaction scores is stored in a computer storage unit or database. This set comprises the outcomes for the targeted or core job to be performed and on the jobs related to the core job; it is used to determine which of the six potential growth paths have the most growth opportunity and which of these outcomes and related jobs can be addressed with the current or core platforms used by job executors. Any set of importance and satisfaction scores may have one or a combination of the 3 types of jobs or outcomes, FIG. 6.

When the importance score is greater than the satisfaction score for a job or outcome statement, that statement is referred to as underserved, when the importance score is less than the satisfaction score, that statement is referred to as overserved and when the importance and satisfaction scores are approximately equal, then the statement is referred to as appropriately served.

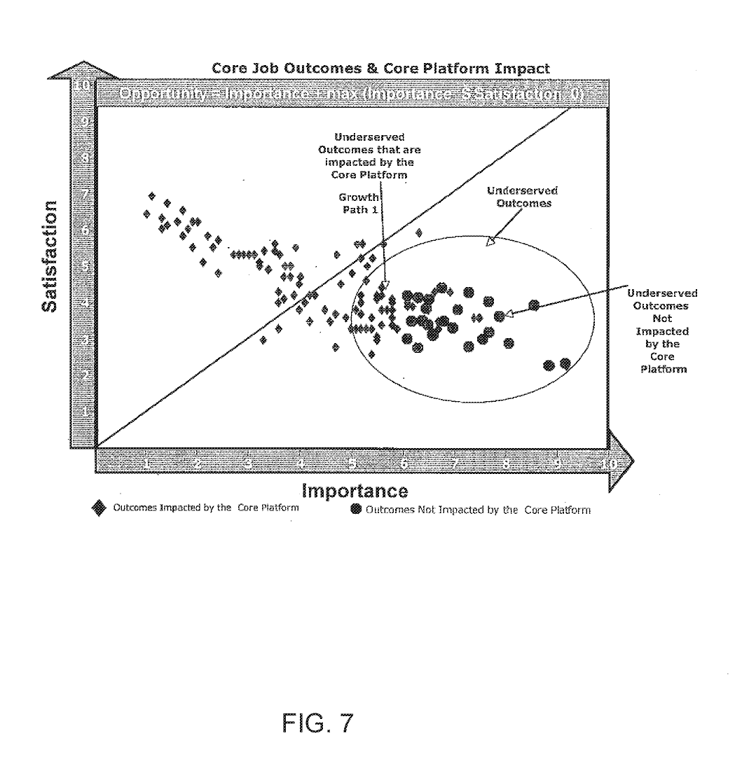

When the importance and satisfaction scores for the outcomes for the core job are underserved (the importance score is greater than the satisfaction score) and those underserved outcomes can be impacted by the core platform that is used by the job executor to perform the job, then a core or sustaining market growth path (Growth Path 1) may be considered (FIG. 7). The output from 230 identifies those underserved outcomes that can be addressed by the core platform. These outcomes may consist of all the underserved outcomes or a subset of underserved outcomes in FIG. 6 that can be.

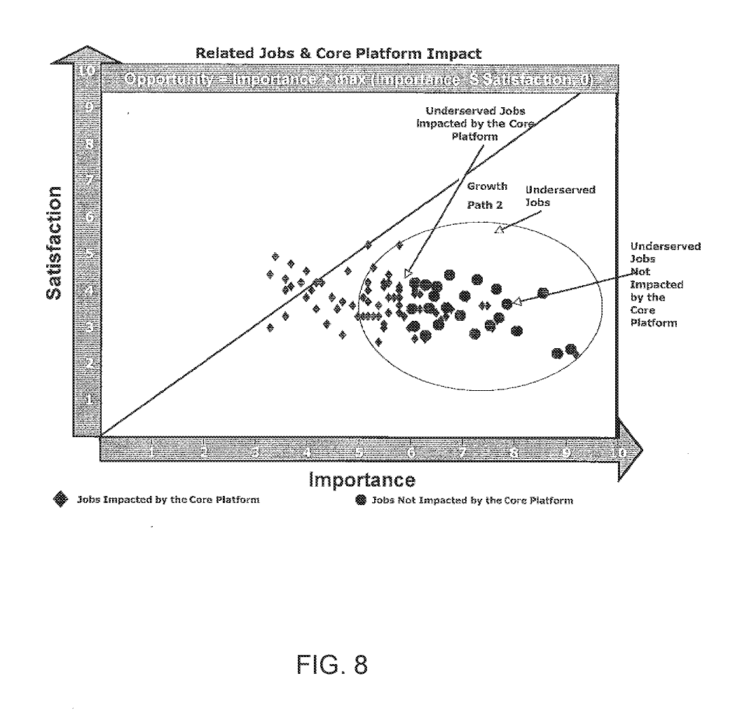

If the related jobs for the existing customer (the current job executor) are under served, (FIG. 8) and can be impacted by the core platform that is used by the job executor to perform the core job, then a Core or Sustaining Market Growth Path (Growth Path 2) should be considered if those jobs can be served without modifying the core platform to enable a feature set that will satisfy those jobs. The output from 230 identifies those underserved jobs that can be addressed by the core platform. These jobs may consist of all the underserved related jobs or a subset of the underserved jobs in FIG. 6 that can be impacted by the core platform.

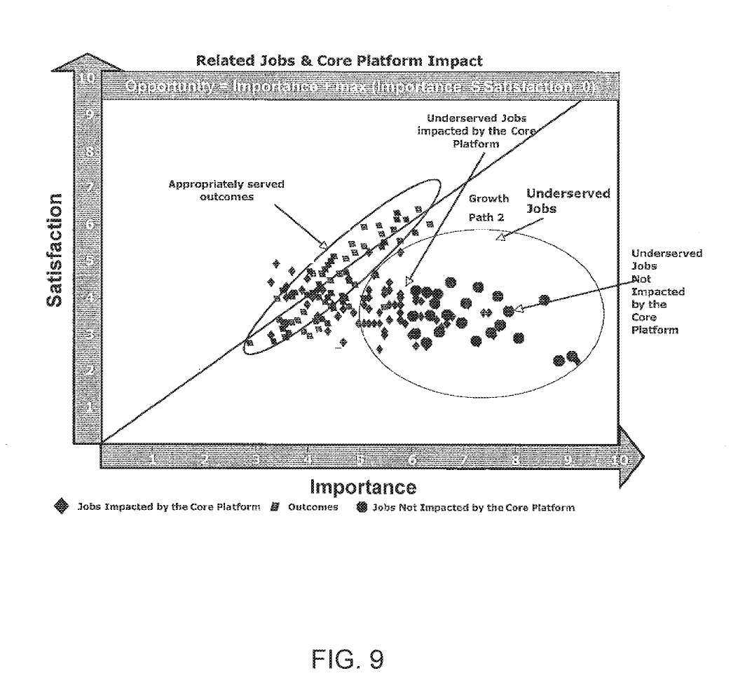

Growth Path 2 is also considered when the outcomes for the core job are appropriately served (importance˜=satisfaction) and the related jobs are underserved as shown in FIG. 9 and can be impacted by the core platform that is used by the job executor to perform the core job, The output from 230 identifies those appropriately served outcomes from the core job, the number of appropriately served outcomes and underserved jobs that can be addressed by the core platform. These jobs may consist of all the underserved related jobs or a subset of the underserved jobs in FIG. 6 that can be impacted by the core platform.

When the output from 230 reflects that the current state of the core platform is unable to impact the outcomes of the core job and/or the related jobs that were identified as underserved, then the process needs modifications to the core platform to enable a feature set to satisfy the jobs related to the core job or a new platform is used to support this feature set then a New Platform Creation Growth Path (Growth Path 3 or 4) is a potential option.

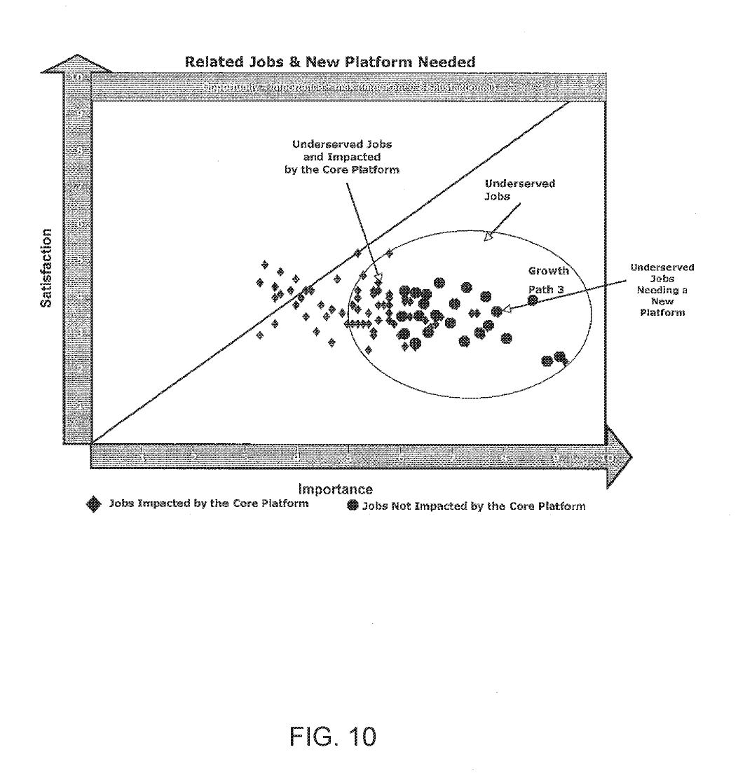

If the core platform is unable to impact the underserved related jobs then the process determines that a new platform is needed to address those jobs (FIG. 10) and Growth Path 3 is a potential option.

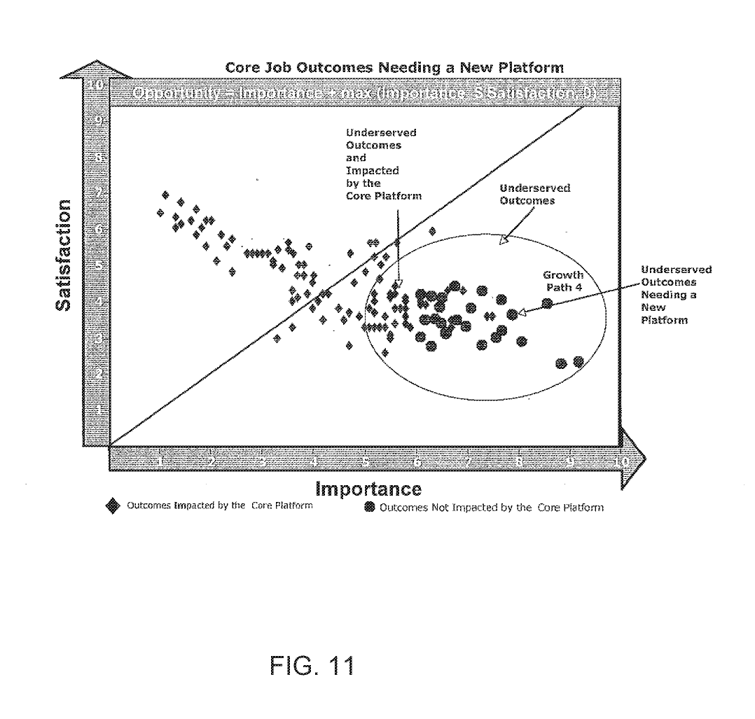

Several scenarios identified by the computer indicate when Growth Path 4 is a potential option. The first scenario involves the underserved outcomes and occurs when the computer output from 230 indicates that the core platform has no ability to impact the outcomes identified by the computer as underserved or when limitations of the core platform are discovered in Generating Features Ideas that Address Unmet Outcomes, 320, make it difficult to achieve the level of performance required for the job executor to experience improvements in satisfying those underserved outcomes. In either case a strategy that will require a new platform to address the underserved outcomes and may also enable the underserved jobs from Growth Path 3 to be addressed (FIG. 11).

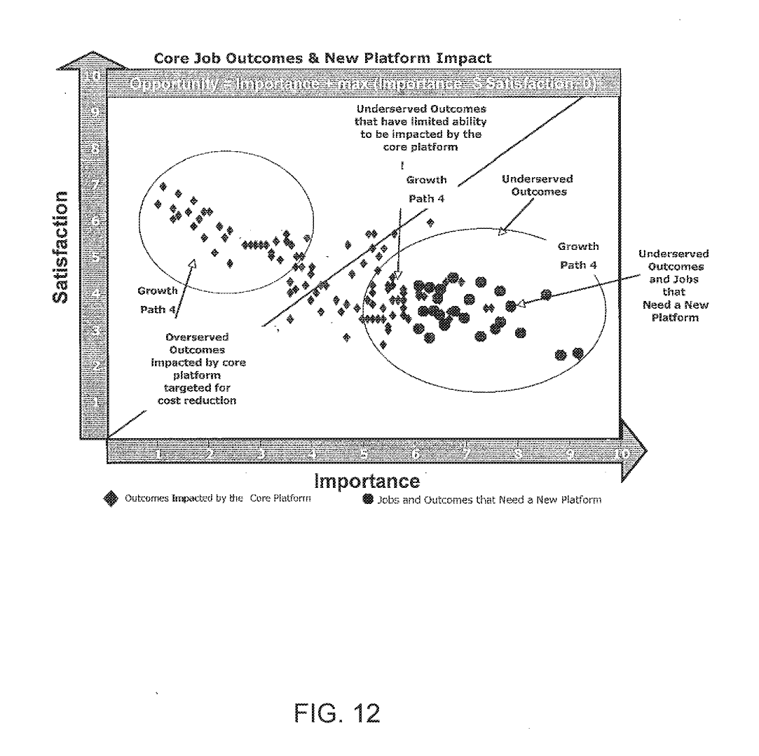

The second scenario occurs when the computer output from 230 identifies when the job executor is over-served (importance<satisfaction) by the existing products and services enabled by the core platform. In this scenario, creating a new platform that will enable the satisfaction the underserved outcomes by lowering the platform costs as well as providing the job executor the ability to execute underserved related jobs is a potential option. The computer output from 230 identifies potential cost reducing opportunities by identifying the overserved outcomes (FIG. 12)

There are some jobs were the person that benefits from that job is not the same person that actually performs that job. These jobs typically require a unique set of skills and/or specialized equipment to perform. For example, it was just a few years ago that if a person wanted the benefits of whiter teeth, then they would go to a dentist or other specialty teeth whitening service provider to perform the job of whitening teeth. Today there are several over-the-counter teeth whitening kits that enable a person to whiten their own teeth without the need to hire a dentist or other skill professional. This made the beneficiary of the teeth whitening job the job executor. When a new platform is created to support a feature set that enables the job beneficiary to become the job executor, consequently eliminating the need for a “specialist” to perform the core job, then a Core Market Disruption Growth Path (Growth Path 5) becomes an option. As with growth path 2, when new jobs are added to a platform that created a new job executor for a core job, then the Related New Market Growth Path (Growth Path 6) is realized. The inputs from 230 are used to determine if Growth Paths 5 and 6 are possible.

Thus, a market growth strategy has been invented that overcomes the deficiencies found in the prior art. Finally, the instant invention greatly enhances the ability of organizations to implement short and long term business forecasting and enables them to rapidly implement changes to meet market needs based upon the nature of the job, the job executor and societal conditions. The following glossary of terms is useful in defining several terms that are used throughout this invention.

### GLOSSARY OF TERMS

1. Innovation is the process of devising product and service concepts that address unmet customer needs and company success criteria without harming society. It results in a concept that connects with all the criteria that is being used to judge its value.
2. A job is defined as a fundamental goal a customer is trying to accomplish or problem they are trying to resolve through an action in a given situation.
3. A market is defined as a demographic (a group of people) and the core job and or related jobs they are trying to get done.
4. A need is specifically defined as a metric that customers use to measure the successful execution of a job. A need is called a desired outcome. A desired outcome can either be underserved, over served, or appropriately served.
5. Company success criteria are the set of financial, strategic and other criteria that a company uses to evaluate the attractiveness of a market, value delivery platform, business model, feature and concept.
6. Societal preservation criteria are the set of success criteria used by society to evaluate the attractiveness of a value delivery platform, feature and concept.
7. An opportunity is defined as an unmet customer need, e.g., an outcome that is both important and unsatisfied with an opportunity score>10.
8. A value delivery platform is the method or mechanism by which value is delivered to the customer, e.g., a service, technology, fleet of trucks, etc. Additionally, a value delivery platform addresses how a job will get done whereas features address how outcomes will be satisfied.
9. A feature is a tangible or intangible function that is integrated into a value delivery platform to satisfy an underserved desired outcome or a job.
10. An idea is a feature that may potentially be chosen for inclusion on a value delivery platform.
11. A product or service concept is produced when a value delivery platform is populated with the feature set that optimizes the concept for profitability, given the chosen business model.
12. A business model is the method by which a company will generate revenue from its concept offering and control costs through is operations to produce profitability for the company, A business model can be optimized around a finite set of criteria that control all aspects of profitability.
13. A growth strategy is a path a company can take to generate growth in a market. For a given market, a company can achieve growth through the execution of six possible strategies.
14. Creativity is the mental process by which an idea is triggered and conceived. Creativity is required to think of an idea (or a concept) that satisfies unmet needs and success criteria.
15. The supply chain is the upstream chain of suppliers.
16. The customer chain is the downstream set of customers.
17. The value chain is a progression that begins with raw material and ending with the sale of the finished product or service.

### Discussion of Hardware, Software and Business Method Implementation Options:

The present invention, as would be known to one of ordinary skill in the art could be produced in hardware or software, or in a combination of hardware and software. The system, or method, according to the inventive principles as disclosed in connection with the preferred embodiment and other embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment and other embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory, or may be on a transportable medium such as a disk, or a fixed disk, or a memory stick, or any other type of memory as known to those of ordinary skill in the art.

The invention is not limited to any particular computer program or logic or language instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, disk drive memory, CD-ROM, and other permanent storage. Additionally, a computer readable medium may include, for example, volatile storage, such as RAM, buffers, cache memory, and network circuits.

Further, the computer readable medium may include computer readable information in a transitory state medium such as a network link and/or a network interface, including a wired network or a wireless network, that allow a computer to read such computer readable medium.

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

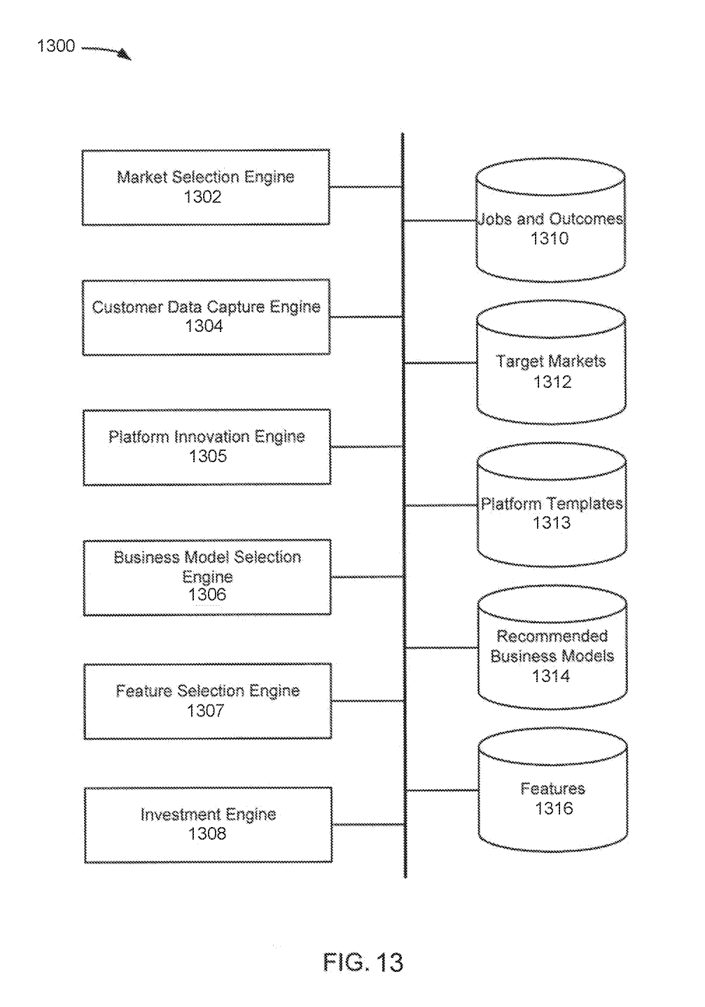

FIG. 13 depicts an example of an MIS system 1300. The MIS system 1300 includes a market selection engine 1302, a customer data capture engine 1304, a platform innovation engine 1305, a business model selection engine 1306, a feature selection engine 1307, an investment engine 1308, a jobs and outcomes database 1310, a target market database 1312, a platform templates database 1313, a recommended business models database 1314, and features database 1316.

The market selection engine 1302 can consider data from the jobs and outcomes database 1310. Table 1 includes examples of data potentially useful in selecting a market that may be extracted from the jobs and outcomes database 1310.

TABLE 1
Market Evaluation Criteria

| | Category | | Market Selection | Threshold | Criteria | Overall |
|---|---|---|---|---|---|---|
| Categories | Weights | | Criteria | Value | Importance | Weights |
| Assess the | 20 | 1. | Revenue potential in the | $0 | 100 | 20.0 |
| revenue | | | market in 3 years | | | |
| potential | | — | Amount of money | | | |
| | | | prospects are willing to | | | |
| | | | spend to get the job done | | | |
| | | | perfectly each time | | | |
| | | — | Number of times per | | | |
| | | | year prospects spend | | | |
| | | | money trying to get the | | | |
| | | | job done | | | |
| | | — | Number of prospects in | | | |
| | | | the stated demographic | | | |
| | | | currently trying to | | | |
| | | | perform the job | | | |
| | | — | Number of prospects in | | | |
| | | | other demographics | | | |
| | | | currently trying to | | | |
| | | | perform the job | | | |
| | | — | Projected year-to-year | | | |
| | | | increase in the number | | | |
| | | | of prospects trying to | | | |
| | | | perform the job (3 year | | | |
| | | | average growth rate) | | | |
| Assess the | 17 | 2. | Percent of prospects | 0% | 50 | 8.5 |
| degree to | | | performing the job who | | | |
| which the | | | say their ability to get | | | |
| customer | | | the job done is | | | |
| needs are | | | underserved | | | |
| underserved | | 3. | Percent of prospects | 0% | 50 | 8.5 |
| | | | performing the job who | | | |
| | | | say their ability to get | | | |
| | | | related consumption jobs | | | |
| | | | done is underserved, | | | |
| | | | e.g., acquiring the | | | |
| | | | product/services, | | | |
| | | | learning how to use, | | | |
| | | | customization, etc. | | | |
| | | — | Percent of prospects | 0% | 0 | 0.0 |
| | | | performing the job who | | | |
| | | | say current methods for | | | |
| | | | acquiring the | | | |
| | | | product/service are | | | |
| | | | underserved, e.g., | | | |
| | | | become aware, choose, | | | |
| | | | purchase, etc. | | | |
| | | — | Percent of prospects | 0% | 0 | 0.0 |
| | | | performing the job who | | | |
| | | | say current methods for | | | |
| | | | learning how to use the | | | |
| | | | product/service are | | | |
| | | | underserved | | | |
| | | — | Percent of prospects | 0% | 0 | 0.0 |
| | | | performing the job who | | | |
| | | | say current methods for | | | |
| | | | product/service | | | |
| | | | customization are | | | |
| | | | underserved | | | |
| | | — | Percent of prospects | 0% | 0 | 0.0 |
| | | | performing the job who | | | |
| | | | say current methods for | | | |
| | | | setting the | | | |
| | | | product/service up are | | | |
| | | | underserved, e.g., | | | |
| | | | preparing it for | | | |
| | | | operation, getting it to | | | |
| | | | work, etc. | | | |
| | | — | Percent of prospects | 0% | 0 | 0.0 |
| | | | performing the job who | | | |
| | | | say current methods for | | | |
| | | | moving customized | | | |
| | | | features to a replacement | | | |
| | | | product/service are | | | |
| | | | underserved, e.g., | | | |
| | | | settings, preferences, | | | |
| | | | passwords, etc. | | | |
| | | — | Percent of prospects | 0% | 0 | 0.0 |
| | | | performing the job who | | | |
| | | | say current methods for | | | |
| | | | interacting with the | | | |
| | | | product/service are | | | |
| | | | underserved | | | |
| | | — | Percent of prospects | 0% | 0 | 0.0 |
| | | | performing the job who | | | |
| | | | say current methods for | | | |
| | | | upkeep of the | | | |
| | | | product/service are | | | |
| | | | underserved | | | |
| | | — | Percent of prospects | 0% | 0 | 0.0 |
| | | | performing the job who | | | |
| | | | say the aesthetics of the | | | |
| | | | product are underserved, | | | |
| | | | e.g., look and feel, fit | | | |
| | | | and finish, etc. | | | |
| | | — | Percent of prospects | 0% | 0 | 0.0 |
| | | | performing the job who | | | |
| | | | say current methods for | | | |
| | | | unpacking the product | | | |
| | | | are underserved, e.g., | | | |
| | | | getting product out of | | | |
| | | | the box, disposing of | | | |
| | | | packaging, etc. | | | |
| | | — | Percent of prospects | 0% | 0 | 0.0 |
| | | | performing the job who | | | |
| | | | say current methods for | | | |
| | | | installing the product are | | | |
| | | | underserved | | | |
| | | — | Percent of prospects | 0% | 0 | 0.0 |
| | | | performing the job who | | | |
| | | | say current methods for | | | |
| | | | storing the product are | | | |
| | | | underserved | | | |
| | | — | Percent of prospects | 0% | 0 | 0.0 |
| | | | performing the job who | | | |
| | | | say current methods for | | | |
| | | | disposing of the product | | | |
| | | | are underserved | | | |
| Assess the | 18 | 4. | Percent of prospects | 0% | 50 | 9.0 |
| cost of getting | | | performing the job who | | | |
| the job done | | | say the cost of getting | | | |
| | | | the job done is excessive | | | |
| | | 5. | Percent of prospects | 0% | 50 | 9.0 |
| | | | performing the job who | | | |
| | | | say the cost of getting | | | |
| | | | related consumption jobs | | | |
| | | | done is excessive | | | |
| | | — | Percent of prospects | 0% | 0 | 0.0 |
| | | | performing the job who | | | |
| | | | say the cost of labor to | | | |
| | | | execute the job is | | | |
| | | | excessive, e.g., cost of | | | |
| | | | operators, support staff, | | | |
| | | | etc. | | | |
| | | — | Percent of prospects | 0% | 0 | 0.0 |
| | | | performing the job who | | | |
| | | | say the cost of operating | | | |
| | | | the product/service is | | | |
| | | | excessive, e.g., cost of | | | |
| | | | consumables, supplies, | | | |
| | | | power, etc. | | | |
| | | — | Percent of prospects | 0% | 0 | 0.0 |
| | | | performing the job who | | | |
| | | | say the cost of shopping | | | |
| | | | for the product/service is | | | |
| | | | excessive, e.g., finding, | | | |
| | | | researching, comparing, | | | |
| | | | etc. | | | |
| | | — | Percent of prospects | 0% | 0 | 0.0 |
| | | | performing the job who | | | |
| | | | say the cost of | | | |
| | | | acquisition is excessive, | | | |
| | | | e.g., product/service | | | |
| | | | purchase price, price of | | | |
| | | | required accessories, etc. | | | |
| | | — | Percent of prospects | 0% | 0 | 0.0 |
| | | | performing the job who | | | |
| | | | say the cost of installing | | | |
| | | | the product/service is | | | |
| | | | excessive | | | |
| | | — | Percent of prospects | 0% | 0 | 0.0 |
| | | | performing the job who | | | |
| | | | say the cost of setting up | | | |
| | | | the product/service is | | | |
| | | | excessive | | | |
| | | — | Percent of prospects | 0% | 0 | 0.0 |
| | | | performing the job who | | | |
| | | | say the cost of learning | | | |
| | | | how to use the | | | |
| | | | product/service is | | | |
| | | | excessive | | | |
| | | — | Percent of prospects | 0% | 0 | 0.0 |
| | | | performing the job who | | | |
| | | | say the cost of | | | |
| | | | customizing the | | | |
| | | | product/service is | | | |
| | | | excessive | | | |
| | | — | Percent of prospects | 0% | 0 | 0.0 |
| | | | performing the job who | | | |
| | | | say the cost of upkeep | | | |
| | | | for the product/service is | | | |
| | | | excessive, e.g., | | | |
| | | | maintaining, repairing, | | | |
| | | | etc. | | | |
| | | — | Percent of prospects | 0% | 0 | 0.0 |
| | | | performing the job who | | | |
| | | | say the cost of storing | | | |
| | | | the product is excessive | | | |
| | | — | Percent of prospects | 0% | 0 | 0.0 |
| | | | performing the job who | | | |
| | | | say the cost of disposing | | | |
| | | | the product is excessive | | | |
| Assess the | 15 | 6. | Degree of experience the | 0% | 34 | 5.1 |
| organization's | | | team has in the market, | | | |
| ability to | | | e.g., with the job of | | | |
| create a | | | interest, with the stated | | | |
| valued | | | demographic, etc. | | | |
| solution | | 7. | Degree to which the | 0% | 33 | 5.0 |
| | | | organization's | | | |
| | | | value- creating processes | | | |
| | | | can be applied in the | | | |
| | | | market, e.g., ability to | | | |
| | | | manufacture, distribute, | | | |
| | | | sell, etc. | | | |
| | | 8. | Probability that the | 0% | 33 | 5.0 |
| | | | organization can | | | |
| | | | overcome competitive | | | |
| | | | barriers to entry, e.g., | | | |
| | | | capital entry | | | |
| | | | requirements, customer | | | |
| | | | brand loyalty, | | | |
| | | | intellectual property | | | |
| | | | rights, etc. | | | |
| Assess the | 15 | 9. | Probability of being a | 0% | 20 | 3.0 |
| organization's | | | market leader* in the | | | |
| ability to | | | long-term, e.g., being | | | |
| sustain a | | | number one, two, three, | | | |
| market | | | etc. | | | |
| leadership | | 10. | Probability that | 0% | 20 | 3.0 |
| position | | | ownership/license | | | |
| | | | opportunities for | | | |
| | | | intellectual property | | | |
| | | | exist, e.g., patents, | | | |
| | | | trademarks, etc. | | | |
| | | 11. | Degree to which the | 0% | 20 | 3.0 |
| | | | organization's | | | |
| | | | value- creating processes | | | |
| | | | cannot be duplicated by | | | |
| | | | other organizations | | | |
| | | 12. | Probability that the | 0% | 20 | 3.0 |
| | | | organization can | | | |
| | | | maintain competitive | | | |
| | | | barriers to entry, e.g., | | | |
| | | | capital entry | | | |
| | | | requirements, customer | | | |
| | | | brand loyalty, | | | |
| | | | intellectual property | | | |
| | | | rights, etc. | | | |
| | | 13. | Probability that | 0% | 20 | 3.0 |
| | | | competitors will be slow | | | |
| | | | to respond to a new | | | |
| | | | market entrant | | | |
| Assess the | 15 | 14. | Probability that market | 0% | 17 | 2.6 |
| risk to the | | | entry will not result in | | | |
| organization | | | exposure to legal | | | |
| of market | | | liabilities | | | |
| entry | | 15. | Probability that market | 0% | 17 | 2.6 |
| | | | entry will not damage | | | |
| | | | relationships with other | | | |
| | | | organizations, e.g., | | | |
| | | | business partners, | | | |
| | | | suppliers, government, | | | |
| | | | etc. | | | |
| | | 16. | Probability that market | 0% | 17 | 2.6 |
| | | | entry will not damage | | | |
| | | | the company's public | | | |
| | | | image | | | |
| | | 17. | Probability that market | 0% | 17 | 2.6 |
| | | | entry will not | | | |
| | | | cannibalize* existing | | | |
| | | | company revenues | | | |
| | | 18. | Probability that the | 0% | 16 | 2.4 |
| | | | company will be able to | | | |
| | | | comply with market | | | |
| | | | regulations, e.g., those | | | |
| | | | imposed by government, | | | |
| | | | trade organizations, | | | |
| | | | consumer advocacy | | | |
| | | | groups, etc. | | | |
| | | 19. | Percent of prospects | 0% | 16 | 2.4 |
| | | | who direct/influence the | | | |
| | | | money/budget to buy | | | |
| | | | solutions to get the job | | | |
| | | | done | | | |
| Other | 0 | 20. | | 0% | 20 | 0.0 |
| | | 21. | | 0% | 20 | 0.0 |
| | | 22. | | 0% | 20 | 0.0 |
| | | 23. | | 0% | 20 | 0.0 |
| | | 24. | | 0% | 20 | 0.0 |

In the example of Table 1, category weights may have default values stored in the job database, and/or may be applied on the fly based upon an analysis of the available data. For example, data may be weighted differently based upon trustworthiness of the data. Trustworthiness may be determined based upon, by way of example but not limitation, an indicated source of the data, the age of the data, etc. Threshold values may be calculated using data in the jobs and outcomes database 1310 or other data that is useful for the analysis. Criteria importance indicates a weight ratio between criteria of a category.

The market selection engine 1302 analyzes the relevant data in the jobs and outcomes database 1310 to determine the size of a market. Advantageously, the market selection engine 1302 can be running to continuously identify markets using potentially changing data points. As data points change, the engine will calculate the most attractive markets for investment. Since the market is, as used in this paper, a job and the job executor, it is possible to identify markets for investment that do not even exist. Sequencing DNA, when it was new, was a job, but there were not tools to do it. At the time, the new market could have been identified even though there were no products or services to sequence DNA. As another example, the market for finding one's car was a zero-dollar solution (write parking space on a piece of paper) until a solution (use GPS) was provided. For illustrative purposes, the largest markets identified are stored in the target market database 1312, which can be updated in real-time.

It may be desirable to augment the jobs and outcomes database 1310 after consulting the target market database 1312. For example, after a target market is identified, it may be advantageous to identify customers in a customer chain who may potentially be involved with any aspect of the job (e.g., raw material provider, parts supplier, manufacturer, OEM, distributor, retailer, service provider, purchase decision-maker, job executor, job beneficiary, and education/training), particularly those customers that are most likely to be unsatisfied and/or on whom you are dependent for success.

The customer data capture engine 1304 considers markets in the target market database 1312, and captures desired outcomes for relevant jobs. The customer data capture engine 1304 can consider a market (a job), the number of job executors and their various outcomes, and the willingness of job executors to pay for a new solution. A target market can be defined as a dollar estimate that is related to the number of job executors times the number of job executors willing to pay. The customer data capture engine 1304 can use a job map for each job to assist in the analysis required to identify outcomes. The customer data capture engine 1304 can also perform or prompt for quantitative market research to capture importance and satisfaction levels customers place on each outcome. This can improve the quality of the results obtained by the business model selection engine 1306.

The platform innovation engine 1305 improves upon a value delivery platform template from the platform templates database 1313. The platform templates database 1313 can include old templates from other platforms. For simplicity, it is assumed that if a template is provided by a human to the platform innovation engine 1305, it is part of the platform templates database 1313, as well. Thus, the platform innovation engine 1305 is referred to as obtaining the template from the database. The template includes parameters associated with various components of a platform that is responsive to a particular job.

The business model selection engine 1306 analyzes the relevant data in the jobs and outcomes database 1310, the target market in the target markets database 1312, and the platform from the platform templates database 1313, to recommend a business model. This can include identifying where a market is under- and over-served and/or identifying segments of opportunity if opportunities are not present in the broad market. The business model selection engine 1306 can calculate cost target ranges, as well as timing targets using individual and portfolio factors.

It may be advantageous to consider three types of criteria when selecting a value delivery platform: Customer, Company, and Society. Tables 2, 3, and 4 include examples from these three categories of data potentially useful in selecting a value delivery platform that may be extracted from the jobs and outcomes database 1310.

TABLE 2
Value Delivery Platform Customer Criteria

| | | Criteria | Threshold |
|---|---|---|---|
| | Platform Selection—Customer Criteria | Importance | Value |
| 1. | Customer's level of satisfaction in | 6 | 0% |
| | getting the job done | | |
| 2. | Customer's level of satisfaction in | 6 | 0% |
| | installing the product/service for use | | |
| 3. | Customer's level of satisfaction in | 6 | 0% |
| | setting up the product/service for use | | |
| 4. | Customer's level of satisfaction in | 6 | 0% |
| | learning to use the product/service | | |
| 5. | Customer's level of satisfaction in | 6 | 0% |
| | customizing the product/service for use | | |
| 6. | Customer's level of satisfaction in using/ | 5 | 0% |
| | interfacing with the product/service | | |
| 7. | Customer's level of satisfaction in | 5 | 0% |
| | maintaining the product/service for use | | |
| 8. | Customer's level of satisfaction in | 5 | 0% |
| | storing the product | | |
| 9. | Customer's level of satisfaction in | 5 | 0% |
| | disposing of the product | | |
| 10. | Customer's cost of acquisition | 5 | 0% |
| 11. | Customer's cost of labor to execute the | 5 | 0% |
| | job of interest | | |
| 12. | Customer's cost of acquiring required | 5 | 0% |
| | ancillary products | | |
| 13. | Customer's cost of learning how to get | 5 | 0% |
| | the job done | | |
| 14. | Customer's cost of customizing the | 5 | 0% |
| | product/service for use | | |
| 15. | Customer's cost of installation | 5 | 0% |
| 16. | Customer's cost of maintenance | 5 | 0% |
| 17. | Customer's cost of storage | 5 | 0% |
| 18. | Customer's cost of disposal | 5 | 0% |
| 19. | Customer's cost of switching solutions | 5 | 0% |
| 20. | Other | 0 | 0% |

TABLE 3
Value Delivery Platform Company Criteria

| | Category | | Platform Selection - | Threshold | Criteria | Overall |
|---|---|---|---|---|---|---|
| Categories | Weights | | Company Criteria | \grave{ }Value | Importance | Weights |
| Ability to | 25 | 1. | Percent probability | 0% | 15 | 3.8 |
| own/capture | | | that the value delivery | | | |
| value that is | | | platform cannot be | | | |
| created | | | copied by a competitor | | | |
| | | 2. | Percent probability | 0% | 15 | 3.8 |
| | | | that the value delivery | | | |
| | | | platform does not | | | |
| | | | contain a competitor's | | | |
| | | | intellectual property | | | |
| | | 3. | Percent probability | 0% | 14 | 3.5 |
| | | | that the value delivery | | | |
| | | | platform erects | | | |
| | | | barriers to competitive | | | |
| | | | entry | | | |
| | | 4. | Percent of targeted | 0% | 14 | 3.5 |
| | | | unmet needs for which | | | |
| | | | features could be | | | |
| | | | devised on this | | | |
| | | | platform | | | |
| | | 5. | Percent of the targeted | 0% | 14 | 3.5 |
| | | | population for which | | | |
| | | | the value delivery | | | |
| | | | platform will not | | | |
| | | | present a cultural | | | |
| | | | taboo, e.g., considered | | | |
| | | | immoral, offensive, | | | |
| | | | against tradition, | | | |
| | | | sacrilegious, etc. | | | |
| | | 6. | Percent probability | 0% | 14 | 3.5 |
| | | | that the value delivery | | | |
| | | | platform can be used | | | |
| | | | to create multiple | | | |
| | | | product lines in the | | | |
| | | | targeted growth path | | | |
| | | 7. | Percent probability | 0% | 14 | 3.5 |
| | | | that the value delivery | | | |
| | | | platform will be | | | |
| | | | reimbursed by a third | | | |
| | | | party, e.g., by | | | |
| | | | insurance companies, | | | |
| | | | governments, etc. | | | |
| Ability to | 25 | 8. | Percent probability | 0% | 15 | 3.8 |
| technically | | | that the value delivery | | | |
| produce the | | | platform can be | | | |
| value delivery | | | developed without | | | |
| platform | | | dependence on | | | |
| | | | invention, e.g., the | | | |
| | | | creation of new | | | |
| | | | materials, new | | | |
| | | | mechanisms, new | | | |
| | | | electronics, etc. | | | |
| | | 9. | Percent probability | 0% | 15 | 3.8 |
| | | | that the technologies | | | |
| | | | chosen for the value | | | |
| | | | delivery platform are | | | |
| | | | technically | | | |
| | | | compatible, e.g., able | | | |
| | | | to interface, work | | | |
| | | | together, fit together, | | | |
| | | | etc. | | | |
| | | 10. | Percent probability | 0% | 14 | 3.5 |
| | | | that the technologies | | | |
| | | | chosen for the value | | | |
| | | | delivery platform will | | | |
| | | | deliver the intended | | | |
| | | | function, e.g., satisfy | | | |
| | | | needs, enhance | | | |
| | | | performance, etc. | | | |
| | | 11. | Percent probability | 0% | 14 | 3.5 |
| | | | that the technologies | | | |
| | | | chosen for the value | | | |
| | | | delivery platform will | | | |
| | | | not combine to | | | |
| | | | produce unwanted | | | |
| | | | side-effects, e.g., an | | | |
| | | | unexpected result, an | | | |
| | | | undesirable outcome, | | | |
| | | | etc. | | | |
| | | 12. | Percent probability | 0% | 14 | 3.5 |
| | | | that the value delivery | | | |
| | | | platform can be | | | |
| | | | developed with | | | |
| | | | equipment that is | | | |
| | | | proven to work in the | | | |
| | | | manufacturing | | | |
| | | | environment, e.g., | | | |
| | | | fabrication, assembly | | | |
| | | | and testing equipment, | | | |
| | | | etc. | | | |
| | | 13. | Percent probability | 0% | 14 | 3.5 |
| | | | that the value delivery | | | |
| | | | platform is producible | | | |
| | | | at needed volumes | | | |
| | | 14. | Percent probability | 0% | 14 | 3.5 |
| | | | that the value delivery | | | |
| | | | platform does not | | | |
| | | | violate an industry | | | |
| | | | standard, e.g., design | | | |
| | | | standards, data | | | |
| | | | exchange standards, | | | |
| | | | trade standards, etc. | | | |
| Ability to | 25 | 15. | Amount of time | 0 | 13 | 3.3 |
| organizationally | | | required to design the | | | |
| deliver the value | | | value delivery | | | |
| delivery | | | platform, e.g., comply | | | |
| platform | | | with regulations, | | | |
| | | | finalize technology | | | |
| | | | implementation, etc. | | | |
| | | 16. | Amount of time | 0 | 13 | 3.3 |
| | | | required to develop the | | | |
| | | | value delivery | | | |
| | | | platform, e.g., | | | |
| | | | engineer a functional | | | |
| | | | product/service, | | | |
| | | | optimize energy | | | |
| | | | consumption, make | | | |
| | | | cost-related trade- offs, | | | |
| | | | etc. | | | |
| | | 17. | Amount of time | 0 | 13 | 3.3 |
| | | | required to create any | | | |
| | | | invention needed to | | | |
| | | | produce/deliver the | | | |
| | | | value delivery | | | |
| | | | platform | | | |
| | | 18. | Amount of time | 0 | 13 | 3.3 |
| | | | required to test the | | | |
| | | | functionality of the | | | |
| | | | value delivery | | | |
| | | | platform, e.g., prove | | | |
| | | | value delivery | | | |
| | | | platform functionality, | | | |
| | | | make needed | | | |
| | | | adjustments, etc. | | | |
| | | 19. | Amount of time | 0 | 12 | 3.0 |
| | | | required to develop the | | | |
| | | | manufacturing process | | | |
| | | | to produce the value | | | |
| | | | delivery platform, e.g., | | | |
| | | | lay out the sequence, | | | |
| | | | decide on equipment | | | |
| | | | needed, test the lines, | | | |
| | | | etc. | | | |
| | | 20. | Amount of time | 0 | 12 | 3.0 |
| | | | required to scale the | | | |
| | | | manufacturing process | | | |
| | | | chosen for the value | | | |
| | | | delivery platform, e.g., | | | |
| | | | obtain needed people, | | | |
| | | | facilities, equipment, | | | |
| | | | etc. | | | |
| | | 21. | Amount of time | 0 | 12 | 3.0 |
| | | | required to enable the | | | |
| | | | supply chain needed to | | | |
| | | | produce the value | | | |
| | | | delivery platform, e.g., | | | |
| | | | identify suppliers, | | | |
| | | | warehousing needs, | | | |
| | | | etc. | | | |
| | | 22. | Amount of time | 0 | 12 | 3.0 |
| | | | required to obtain | | | |
| | | | necessary regulatory | | | |
| | | | approvals, e.g., federal | | | |
| | | | government, state | | | |
| | | | government, | | | |
| | | | international | | | |
| | | | regulations, etc. | | | |
| Ability to invest | 25 | 23. | Cost required to design | $0.00 | 13 | 3.3 |
| in the creation | | | the value delivery | | | |
| | | | platform, e.g., add | | | |
| | | | features, comply with | | | |
| | | | regulations, finalize | | | |
| | | | technology | | | |
| | | | implementation, etc. | | | |
| | | 24. | Cost required to | $0.00 | 13 | 3.3 |
| | | | develop the value | | | |
| | | | delivery platform, e.g., | | | |
| | | | engineer a functional | | | |
| | | | product/service, | | | |
| | | | optimize energy | | | |
| | | | consumption, make | | | |
| | | | cost-related trade- offs, | | | |
| | | | etc. | | | |
| | | 25. | Cost required to test | $0.00 | 13 | 3.3 |
| | | | the functionality of the | | | |
| | | | value delivery | | | |
| | | | platform, e.g., prove | | | |
| | | | value delivery | | | |
| | | | platform functionality, | | | |
| | | | make needed | | | |
| | | | adjustments, etc. | | | |
| | | 26. | Cost required to | $0.00 | 13 | 3.3 |
| | | | develop the | | | |
| | | | manufacturing process | | | |
| | | | to produce the value | | | |
| | | | delivery platform, e.g., | | | |
| | | | lay out the sequence, | | | |
| | | | decide on equipment | | | |
| | | | needed, test the lines, | | | |
| | | | etc. | | | |
| | | 27. | Cost required to scale | $0.00 | 12 | 3.0 |
| | | | the manufacturing | | | |
| | | | process chosen for the | | | |
| | | | value delivery | | | |
| | | | platform, e.g., obtain | | | |
| | | | needed people, | | | |
| | | | facilities, equipment, | | | |
| | | | etc. | | | |
| | | 28. | Cost required to | $0.00 | 12 | 3.0 |
| | | | set- up the supply | | | |
| | | | chain needed to | | | |
| | | | produce the value | | | |
| | | | delivery platform, e.g., | | | |
| | | | identify suppliers, | | | |
| | | | warehousing needs, | | | |
| | | | etc. | | | |
| | | 29. | Cost required to obtain | $0.00 | 12 | 3.0 |
| | | | the necessary | | | |
| | | | regulatory approvals, | | | |
| | | | e.g., federal | | | |
| | | | government, state | | | |
| | | | government, | | | |
| | | | international | | | |
| | | | regulations, etc. | | | |
| | | 30. | Cost of on-going | $0.00 | 12 | 3.0 |
| | | | operations, e.g., fixed | | | |
| | | | costs, variable costs, | | | |
| | | | etc. | | | |
| Other | 0 | 31. | | 0% | 20 | 0.0 |
| | | 32. | | 0% | 20 | 0.0 |
| | | 33. | | 0% | 20 | 0.0 |
| | | 34. | | 0% | 20 | 0.0 |
| | | 35. | | 0% | 20 | 0.0 |

TABLE 4
Value Delivery Platform Societal Criteria

| | Criteria | Thresh- |
|---|---|---|
| | Impor- | old |
| Platform Selection—Societal Criteria | tance | Value |
| Percent probability that the value delivery platform | 9 | 0% |
| does not pose a health risk to the user, e.g., the threat | | |
| of injury, disease, addiction, chronic condition, etc. | | |
| Percent probability that the value delivery platform | 9 | 0% |
| does not pose a health risk to others, e.g., children, | | |
| bystanders, etc. | | |
| Percent probability that the value delivery platform | 9 | 0% |
| will conserve the earth's natural resources, e.g., oil, | | |
| water, minerals, trees, etc. | | |
| Percent probability that the value delivery platform | 9 | 0% |
| will not pollute the earth's environment, e.g., air, | | |
| water, soil, etc. | | |
| Percent probability that the value delivery platform | 8 | 0% |
| will preserve the earth's natural habitat, e.g., | | |
| preserve the balance in the food chain, not upset | | |
| the natural order, etc. | | |
| Percent probability that the value delivery platform | 8 | 0% |
| will not contribute to world hunger, e.g., cause | | |
| famine, food shortages, a poisoned food supply, etc. | | |
| Percent probability that the value delivery platform | 8 | 0% |
| will not contribute to crime, e.g., cause vandalism, | | |
| robbery, assault, etc. | | |
| Percent probability that the value delivery | 8 | 0% |
| platform will not degrade the world's standard of | | |
| living, e.g., destroy wealth, cause poverty, etc. | | |
| Percent probability that the value delivery | 8 | 0% |
| platform will not contribute to social injustice, e.g., | | |
| cause repression, prejudice, sexism, etc. | | |
| Percent probability that the value delivery platform | 8 | 0% |
| will not contribute to social instability, e.g., | | |
| cause the division of people, discontent, etc. | | |
| Percent probability that the value delivery | 8 | 0% |
| platform does not result in the invasion of | | |
| the customer's privacy | | |
| Percent probability that the value delivery platform | 8 | 0% |
| does not violate a governmental regulatory agency | | |
| requirement, e.g., federal, state, international, etc. | | |
| Other | 0 | 0% |

The business model selection engine 1306 uses company criteria for selection of the appropriate business model for the delivery platform. Table 5 includes examples of potentially useful data.

TABLE 5
Business Model Company Criteria

Maximize revenue
Amount of revenue from primary product sales
Amount of revenue from primary service sales
Amount of revenue from ancillary product sales, e.g., options,
add-ons, etc.
Amount of revenue from ancillary service sales, e.g., training,
consulting, etc.
Amount of revenue from product upgrade sales
Amount of revenue from product/service customization sales
Amount of revenue from licenses and royalties
Amount of revenue from leases and rents, e.g., facilities, equipment, etc.
Amount of revenue from product installation sales
Amount of revenue from product maintenance sales
Amount of revenue from product disposal sales
Amount of revenue from donations and contributions
Amount of revenue from fines, forfeitures, and penalties
Amount of revenue from other sources, e.g., advertising, grants, etc.
Minimize fixed costs
Cost of manufacturing equipment
Cost of test equipment
Cost of distribution equipment, e.g., transportation, warehousing, etc.
Cost of information technology equipment
Cost of facility build-out
Cost of facilities, e.g., lease, rent, mortgage, etc.
Cost of puffing the installation infrastructure in place
Cost of putting the maintenance infrastructure in place
Cost of puffing the disposal infrastructure in place
Cost of regulatory compliance, e.g., inspection fees, impact fees,
permit fees, etc.
Cost of acquiring necessary competencies, e.g., marketing,
manufacturing, R&D, etc.
Minimize variable costs
Cost of labor
Cost of goods sold, e.g., parts, materials, etc.
Cost of distribution, e.g., transportation, channel costs, etc.
Cost of overhead, e.g., management expenses, administrative
expenses, etc.
Cost of inventory
Cost of taxes
Cost of product installation
Cost of product maintenance
Cost of product disposal
Optimize profit margins
Percent profit margin
Percent probability that the targeted profit margin will be achieved
Maintain business relationships
Percent probability that the business model will not damage established
relationships with other companies, e.g., stifle cooperation,
force competitiveness, undermine trust, etc.
Percent probability that the business model will not impede the
set-up of the supply chain
Percent probability that the business model will not impede the
on-going effectiveness of the supply chain
Time to profit
First to market
Time to market

The feature selection engine 1307 adds features to the platform after a basic business model has been selected by the business model selection engine 1306. The feature selection engine 1307 can use multiple criteria to add or assist in the addition of features. The features database 1316 includes entries associated with various types of features, such as applications (for use with a computer-implemented or Internet platform), telephone answering service parameters, power sources, etc. Features are the components added to a platform that directly address outcomes. Thus, they can be implicitly or explicitly tied to the jobs and outcomes of the jobs and outcomes database 1310. Tables 6, 7, and 14 provide examples of data that would potentially be useful for such a determination.

TABLE 6
Customer Criteria

Customer benefit metrics
Degree to which customer satisfaction of targeted outcomes is
improved by the feature, i.e., number of outcomes
better satisfied and degree to which each is improved
Percent decrease in the customer's cost of acquisition
Customer cost metrics
Degree to which customer satisfaction of non-targeted
outcomes is decreased by the feature
Percent reduction in the customer's level of satisfaction in
installing the product/service for use
Percent reduction in the customer's level of satisfaction in
setting up the product/service for use
Percent reduction in the customer's level of satisfaction in
learning to use the product/service
Percent reduction in the customer's level of satisfaction in
customizing the product/service for use
Percent reduction in the customer's level of satisfaction in
using/interfacing with the product/service
Percent reduction in the customer's level of satisfaction in
maintaining up the product/service for use
Percent reduction in the customer's level of satisfaction in
storing the product
Percent reduction in the customer's level of satisfaction
in disposing of the product
Percent increase in the customer's cost of acquisition
Percent increase in the customer's cost of labor to execute the
job of interest
Percent increase in the customer's cost of acquiring required
ancillary products
Percent increase in the customer's cost of learning how to get
the job done
Percent increase in the customer's cost of customizing the
product/service for use
Percent increase in the customer's cost of installation
Percent increase in the customer's cost of maintenance
Percent increase in the customer's cost of storage
Percent increase in the customer's cost of disposal

TABLE 7
Company Criteria

Ability to own/capture value that is created
Percent probability that the feature cannot be copied by a competitor
Percent probability that the feature does not contain a competitor's
intellectual property
Percent probability that the feature erects barriers to competitive entry
Percent of the targeted population for which the feature will not
present a cultural taboo, e.g., considered immoral, offensive,
against tradition, sacrilegious, etc.
Percent probability that the feature can be used in multiple product
lines in the targeted growth path
Ability to technically produce the feature
Percent probability that the feature can be developed without
dependence on invention, e.g., the creation of new materials,
new mechanisms, new electronics, etc.
Percent probability that the technologies chosen for the feature
are technically compatible, e.g., able to interface, work
together, fit together, etc.
Percent probability that the technologies chosen for the feature
will deliver the intended function, e.g., satisfy needs,
enhance performance, etc.
Percent probability that the technologies chosen for the feature
will not combine to produce unwanted side-effects, e.g.,
an unexpected result, an undesirable outcome, etc.
Percent probability that the feature can be developed with equipment
that is proven to work in the manufacturing environment,
e.g., fabrication, assembly and testing equipment, etc.
Percent probability that the feature is producible at needed volumes
Percent probability that the feature does not violate an industry
standard, e.g., design standards, data exchange standards,
trade standards, etc.
Percent probability that the feature does not duplicate functionality,
e.g., functionality existing in the platform, in other features, etc.
Percent probability that the feature works with other features
without negating their performance
Ability to organizationally deliver the feature
Amount of time required to design the feature, e.g., comply with
regulations, finalize technology implementation, etc.
Amount of time required to develop the feature, e.g., engineer
the function, optimize energy consumption, make
cost-related trade-offs, etc.
Amount of time required to create any invention needed to
produce/deliver the feature
Amount of time required to test the functionality of the feature,
e.g., prove feature functionality, make needed adjustments, etc.
Amount of time required to develop the manufacturing process
to produce the feature, e.g., lay out the sequence, decide on
equipment needed, test the lines, etc.
Amount of time required to scale the manufacturing process chosen
for the feature, e.g., obtain needed people, facilities, equipment, etc.
Amount of time required to set-up the supply chain needed to
produce the feature, e.g., identify suppliers, warehousing needs, etc.
Amount of time required to obtain necessary regulatory approvals,
e.g., federal government, state government, international regulations, etc.
growth
Ability to afford the creation of the feature
Cost required to design the feature, e.g., make trade-offs,
comply with regulations, finalize technology implementation, etc.
Cost required to develop the feature, e.g., engineer the function,
optimize energy consumption, make cost-related trade-offs, etc.
Cost required to test the functionality of the feature, e.g., prove
feature functionality, make needed adjustments, etc.
Cost required to develop the manufacturing process to produce
the feature, e.g., lay out the sequence, decide on equipment
needed, test the lines, etc.
Cost required to scale the manufacturing process chosen for the feature,
e.g., obtain needed people, facilities, equipment, etc.
Cost required to set-up the supply chain needed to produce the
feature, e.g., identify suppliers, warehousing needs, etc.
Cost required to obtain the necessary regulatory approvals, e.g.,
federal government, state government, international regulations, etc.
Feature costs—to go into documentation sheet
Development costs
Bill of material costs

TABLE 8
Societal Criteria

Percent probability that the feature does not pose a health risk to
the user, e.g., the threat of injury, disease, chronic condition, etc.
Percent probability that the feature does not pose a health risk to
others, e.g., children, bystanders, etc.
Percent probability that the feature will conserve the earth's
natural resources, e.g., oil, water, minerals, trees, etc.
Percent probability that the feature will not pollute the earth's
environment, e.g., air, water, soil, etc.
Percent probability that the feature will preserve the earth's natural
habitat, e.g., preserve the balance in the food chain, not upset the
natural order, etc.
Percent probability that the feature will not contribute to world hunger,
e.g., cause famine, food shortages, a poisoned food supply, etc.
Percent probability that the feature will not contribute to crime, e.g.,
cause vandalism, robbery, assault, etc.
Percent probability that the feature will not degrade the world's
standard of living, e.g., destroy wealth, cause poverty, etc.
Percent probability that the feature will not contribute to social
injustice, e.g., cause repression, prejudice, sexism, etc.
Percent probability that the feature will not contribute to social
instability, e.g., cause the division of people, discontent, etc.
Percent probability that the feature does not result in the invasion
of the customer's privacy
Percent probability that the feature does not violate a
governmental regulatory agency requirement,
e.g., federal, state, international, etc.

After the features are selected, the business model selection engine 1306 can construct or facilitate the construction of a set of product or service models, estimate or facilitate making an estimate of the cost and price point of each model, and in general make the basic business model more comprehensive. It has been found that attempting to generate features prior to the basic business model is wasteful of resources, and attempting to generate a comprehensive business model without first considering features is difficult for an artificial intelligence, and for a human, for that matter. For illustrative purposes, the best business models are stored in the recommended business models database 1314. The recommended business models may include a rating of investment quality (e.g., estimated risk and/or reward).

The investment engine 1308 considers the data from each of the databases and provides an investment recommendation. Because of the job-based approach providing funding to various aspects of a product or service model could be automated.

It may be noted that at various points in the system 1300, user input may be desirable if the artificial intelligence of the system is not up to a particular task. In some cases, the combination of computer data processing and human intelligence can be useful for identifying or quantifying different aspects of a problem.

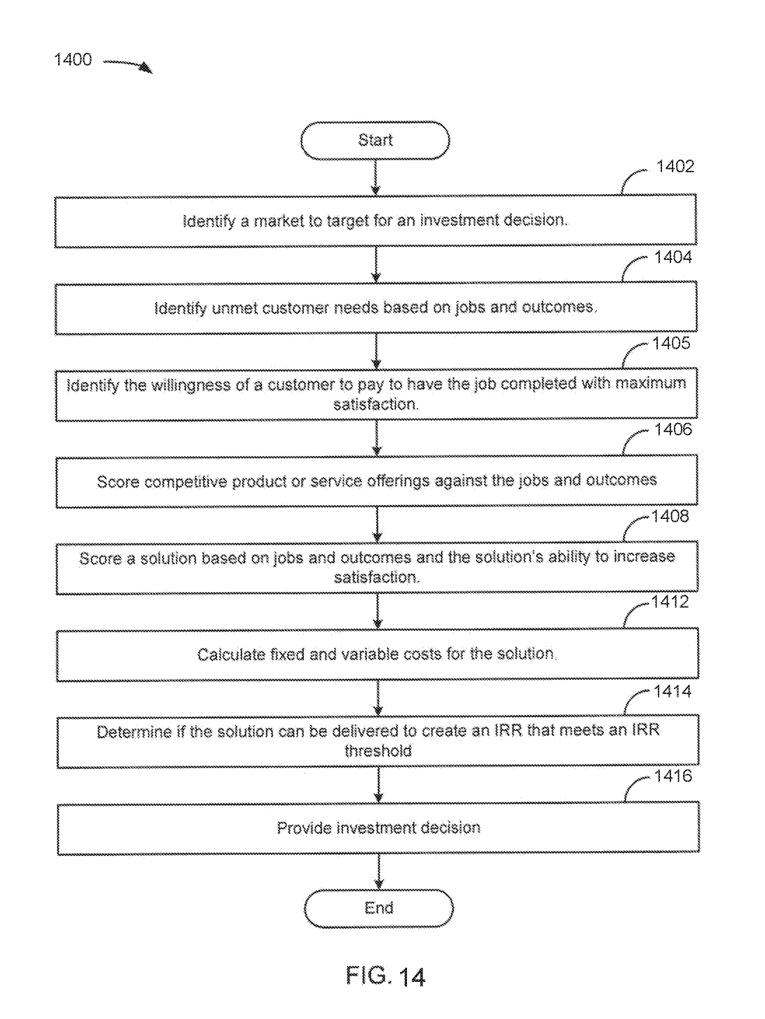

FIG. 14 depicts a flowchart 1400 of an example of a method for providing an investment decision based on a product or service's ability to satisfy unmet customer needs and a company's ability to create and capture financial returns from investing in the development and sales of the product or service. In a specific implementation, hundreds of different inputs related to the market opportunity, the customer need (the customer jobs and their outcomes), the competitors, the solution, the pricing, costs, and financing are considered.

The method is organized as a sequence of modules in the flowchart 1400. However, it should be understood that these and other modules associated with other methods described herein may be reordered for parallel execution or into different sequences of modules. One or more of the modules (or portions thereof) may be implemented on a computer readable medium for access and/or execution by a computer.

In the example of FIG. 14, the flowchart 1400 starts at module 1402 with identifying a market to target for an investment decision. The market can be defined as a demographic (e.g., a group of people) and the job or jobs they are trying to accomplish (e.g., the goal they are trying to achieve or problem they are trying to solve for a given situation). A number of different inputs are used to determine if the market meets the threshold criteria level. Examples of such inputs were illustrated with reference to FIG. 13.

In the example of FIG. 14, the flowchart 1400 continues to module 1404 with identifying unmet customer needs based on jobs (e.g., the goals the customer is trying to accomplish) and outcomes (e.g., the measurable outcomes related to the speed, stability, and output of performing the job). Each job and outcome can be rated for its importance and satisfaction level by the customer, an opportunity score algorithm such as this one: opportunity score=importance+max(importance−satisfaction, 0).

For each customer job, in a specific implementation, there can be 50 to 150 different outcomes and the opportunity score represents if the outcome or job is underserved, appropriately served or over served. If the opportunity score for a job or outcome fails to exceed an opportunity threshold (e.g., the opportunity score is indicative of an appropriately served or over served job), the investment engine can determine if there is a segment of the customers (e.g., a specific part of the demographic) that views the job or outcome as being underserved. This facilitates defining a market with more granularity or identifying underserved “niche” jobs in an appropriately served or over served market.

In the example of FIG. 14, the flowchart 1400 continues to module 1405 with identifying the willingness of a customer to pay to have the job completed with maximum satisfaction, or 100% satisfaction levels. Pricing inputs can be used to determine customer willingness to pay.

In the example of FIG. 14, the flowchart 1400 continues to module 1406 with scoring the competitive product or service offerings against the jobs and outcomes to determine how well each offering is satisfying the customers.

In the example of FIG. 14, the flowchart 1400 continues to module 1408 with scoring the solution based on jobs and outcomes and the solution's ability to increase satisfaction. The value add of the solution is based on the weighted average of the opportunity score. The value add of a solution is based on satisfying the outcomes. An example of a weighted average adequate to represent a value add, V, is:

V==(V_{new}−V_{old})/V_{old},

where V_{new} is the new value score and V_{old} is the old value score.

The old value score can be represented by, for example, this equation:

V_{old}=Σ(Oᵢ/Sᵢ),

where Oᵢ is the old satisfaction value for an i^{th} job and Sᵢ is the maximum satisfaction value for the i^{th} job.

The new value score can be represented by, for example, this equation:

V_{new}=Σ[Nᵢ*(Oᵢ/Sᵢ)],

where Nᵢ, is the new satisfaction value for an i^{th} job.

In the example of FIG. 14, the flowchart 1400 continues to module 1412 with calculating fixed and variable costs for the solution. Pricing, solution satisfaction, and cost can be used to determine whether a cost can be used to produce and deliver the solution to the customer and those costs plus the customer's willingness to pay and the solution satisfaction levels to determine the financial value of the solution.

In the example of FIG. 14, the flowchart 1400 continues to module 1414 with determining if the solution can be delivered to create an investment rate of return (IRR) that meets an IRR threshold.

In the example of FIG. 14, the flowchart 1400 continues to module 1416 with providing an investment decision. Advantageously, by using the tool, high-quality investment decisions can be largely automated based upon comparisons with competitor tools and a database of successfully generated tools (platform templates).

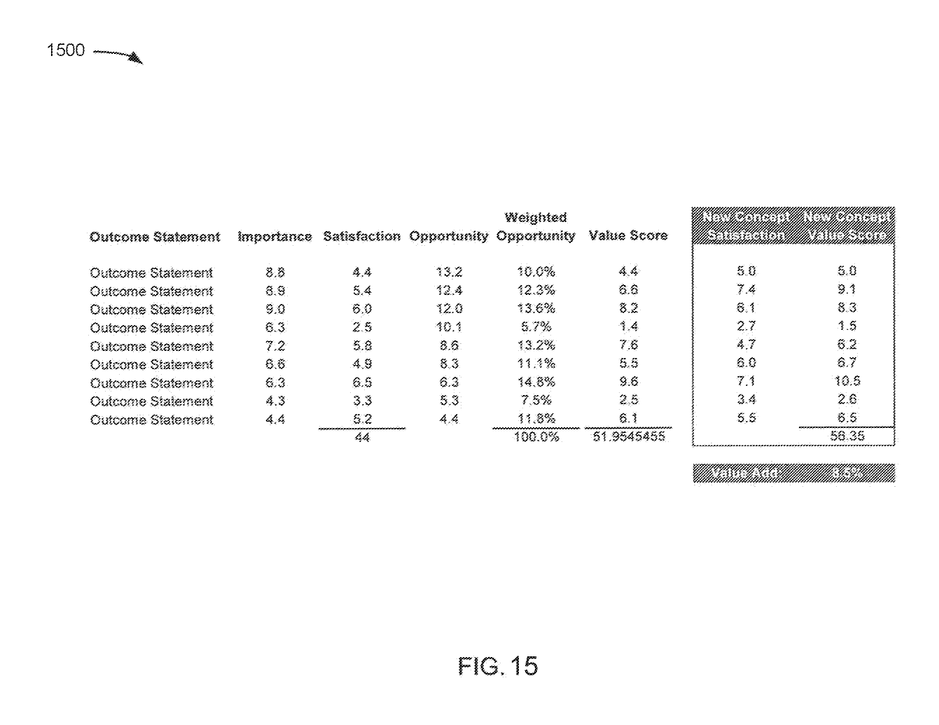

FIG. 15 is intended to illustrate an example of a value add proposition for several outcome statements using techniques described with reference to FIGS. 13 and 14.

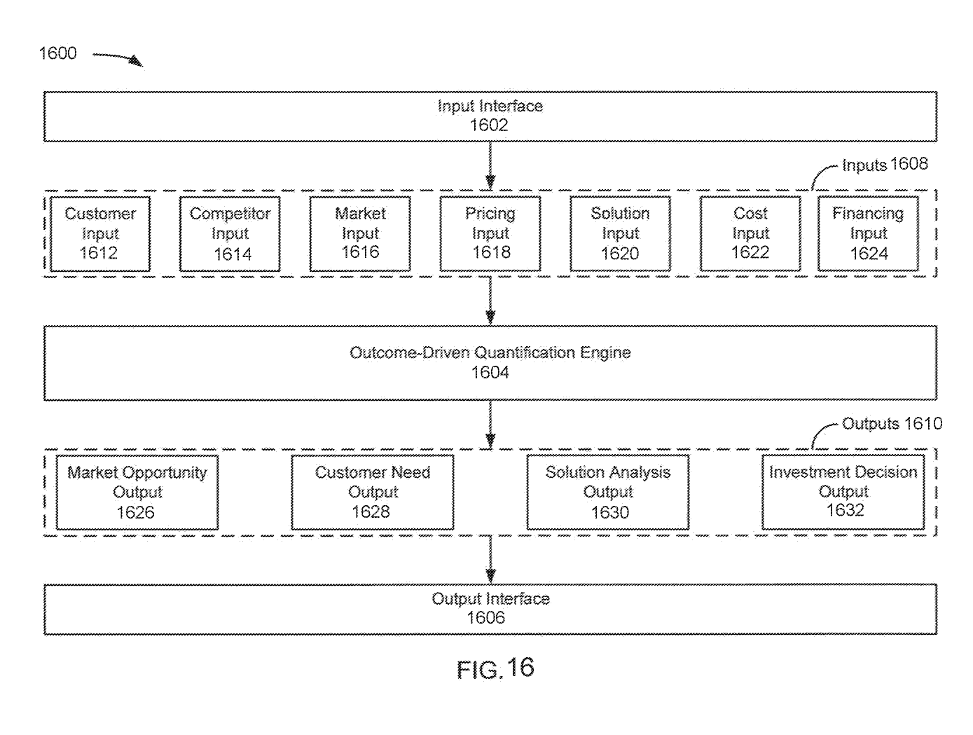

FIG. 16 depicts an example of a system 1600 for making investment decisions. FIG. 16 includes an input interface 1602, an outcome-driven quantification engine 1604, and an output interface 1606. The outcome-driven quantification engine 1604 is coupled to the input interface 1602 and the output interface 1606.

The input interface 1602 may include one or more known or convenient hardware devices (such as keyboard, mouse, USB port, storage medium, etc.) and/or software or firmware modules (such as drivers, database interfaces, etc.). The exact nature of the input interface 1602 is not critical so long as the interface is capable of providing computer-readable data. As is known in the relevant art, in operation the input interface 1602 is typically coupled to one or more processors.

The outcome-driven quantification engine 1604 includes software modules (e.g., data and executables). When the software modules are implemented on a hardware device (e.g., memory)—or on some other known or convenient machine, manufacture, or composition of matter capable of storing data and/or instructions, at least ephemerally, thereon—this may be referred to as implementing the outcome-driven quantification engine 1604 in a computer-readable medium. A computer readable medium can be coupled to a processor in a known or convenient manner.

The outcome-driven quantification engine 1604 has various techniques to quantify a venture. For example, the outcome-driven quantification engine 1604 can include algorithms based on customer needs (e.g., jobs and outcomes), importance, and satisfaction. In a specific implementation, the outcome-driven quantification engine 1604 is capable of processing large amounts of data in real time or near-real time. This is advantageous because due to the amount of data and varying market or other conditions, it may be desirable to use the engine multiple times for different models.

The output interface 1606 may include one or more known or convenient hardware devices (such as monitor, printer, USB port, storage medium, etc.) and/or software or firmware modules (such as drivers, database interfaces, etc.). The exact nature of the output interface 1606 is not critical so long as the interface is capable of providing computer-readable data. As is known in the relevant art, in operation the output interface 1606 is typically coupled to one or more processors.

In the example of FIG. 16, in operation, the input interface 1602 provides inputs 1608 to the outcome-driven quantification engine 1604. The inputs 1608 may be provided from a remote or external source over a network, from a local input device, or from local storage (e.g., from a hard disk). The inputs 1608 can be real-time input from a panel of experts, data from databases, direct input from a user of the system 1600, etc. In the example of FIG. 16, the inputs 1608 include customer input 1612, competitor input 1614, market input 1616, pricing input 1618, solution input 1620, cost input 1622, and financing input 1624.

The customer input 1612 can include discrete jobs. Advantageously, jobs have quantifiable importance and satisfaction levels. Theoretically, the customer input 1612 can include any number of jobs, but current empirical models provide for dozens or hundreds of jobs. While one or just a few jobs could be input, an advantage of the system 1600 is that it can process practically any number of jobs in a manner that may not be possible for a human. The customer input 1612 can also include outcomes for discrete jobs. Outcomes include goals that, e.g., a customer is trying to reach. Advantageously, outcomes can also have quantifiable importance and satisfaction levels.

The competitor input 1614 can include discrete jobs that can be quantifiable in importance and satisfaction levels. However, unlike customer input, competitor inputs for jobs are based on a competitive product or service. The competitive product or service may be an actual one, or a theoretical one. The competitor input 1614 can also include outcomes for discrete jobs.

The market input 1616 can include discrete jobs. The discrete jobs are, for example, jobs that a demographic is attempting to accomplish. The market input 1616 can also include demographic data. Demographic data can include, for example, a size and description of a demographic that is attempting to accomplish a job.

The pricing input 1618 can include discrete jobs. Pricing inputs for discrete jobs may represent the willingness to pay to complete the job perfectly (as used herein, perfect is intended to mean as near to perfect as is reasonable for a given job) for a demographic that is trying to get the job done. The pricing input 1618 can also include outcomes for discrete jobs. Outcomes, in this case, can represent an incremental willingness to pay to satisfy an outcome perfectly for a demographic.

The solution input 1620 can include discrete jobs. Solution inputs for jobs can have quantifiable importance and satisfaction levels of completing a job with a specific solution. The solution input 1620 can also include outcomes for the jobs, which can have quantifiable importance and satisfaction levels of job outcome with the specific solution.

The cost input 1622 can have discrete jobs that represent costs to deliver a solution for the job, and the outcomes.

The financing input 1624 can include different options for financing growth of a company. For example, the financing input 1624 can include the cost of capital and IRR hurdles.

The outcome-driven quantification engine 1604 processes the inputs 1608 to produce outputs 1610. The operation of the outcome-driven quantification engine 1604 is described in more detail later in this paper. Depending upon the implementation, the outcome-driven quantification engine 1604 can use feedback on success in order to learn, and thereby improve the accuracy of the outputs 1610. The outputs 1610 may be provided to a remote or external source over a network, to a local display, or to local storage (e.g., to a hard disk) for later use. In the example of FIG. 16, the outputs 1610 include market opportunity output 1626, customer need output 1628, solution analysis output 1630, and investment decision output 1632.

The market opportunity output 1626 can take into consideration all of the inputs 1608 and scores the market opportunity. The market opportunity output 1626 should identify the degree to which there is a market opportunity based upon, for example, unmet customer needs, competitive products, etc.

The customer need output 1628 takes into consideration job and outcome scores (e.g., satisfaction levels). The customer need output 1628 should identify unmet customer need based on importance and satisfaction levels of jobs and outcomes.

The solution analysis output 1630 takes into consideration job and outcome scores (e.g., satisfaction levels) of different solution ideas. The solution analysis output 1630 should identify a degree to which a solution adds value based on job and outcome satisfaction levels.

The investment decision output 1632 takes into consideration all of the inputs 1608. The investment decision output 1632 should identify whether an investment is warranted and expected returns.

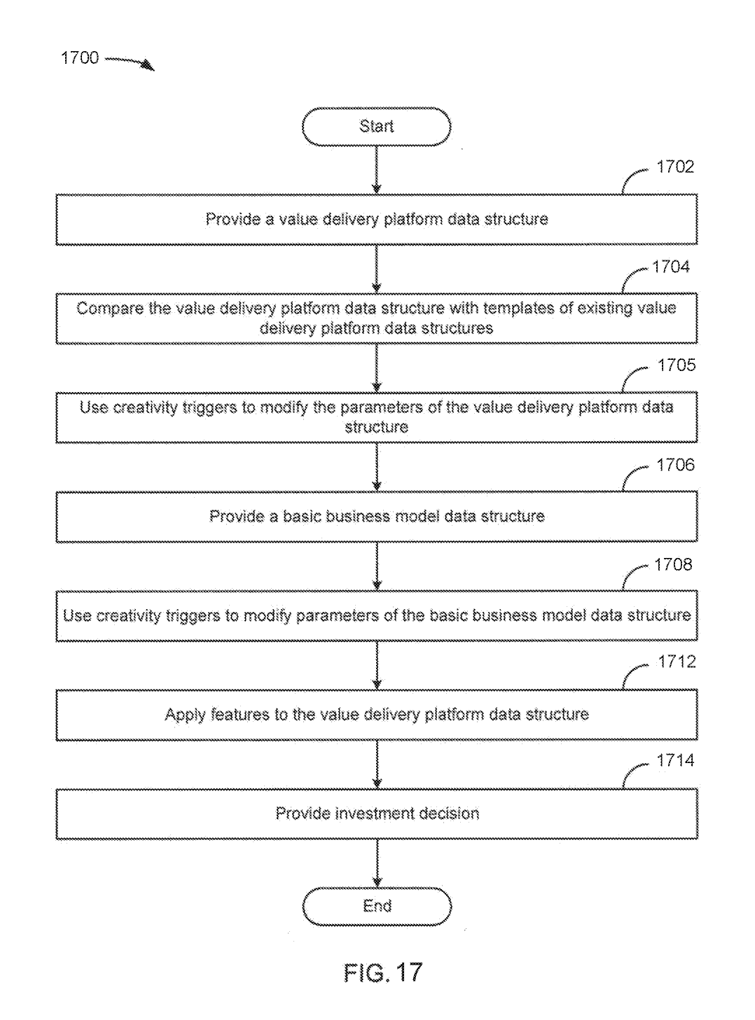

FIG. 17 depicts a flowchart 1700 of an example of a method for providing an investment decision based on a strictly hierarchical approach that generates a platform before generating a basic business model before generating features for the platform to directly address outcomes. Where a platform is provided in advance, the flowchart can begin at module 1708. Where a basic business model is provided in advance, the flowchart can begin at module 1712. This method may take advantage of competitive product or service offerings that have already been scored against jobs and outcomes. (For example, the modules 1702-1712 of FIG. 17 could be inserted into the flowchart 1400 between modules 1406 and 1408.)

In the example of FIG. 17, the flowchart 1700 starts at module 1702 with providing a value delivery platform data structure. A framework for focused idea generation includes the following rules: 1) Conduct idea generation for only one type of idea at a time. The types of ideas are platform, business model, and feature set. If the goal is to generate a new platform, then those involved in the creative process should generate ideas only for the new platform, not ideas related to a business model or features. Failure to follow this rule can result in a mix of ideas that cannot be considered or evaluated together. 2) Generate ideas for platforms, then business models, then features. For radical innovation, the platform should be approved by management before moving on to business model ideation, and the business model should be approved by management before moving on to feature set ideation. This sequence improves efficiency by decreasing the probability of wasting time and effort on unused business models or features. Of course, if the platform and business model are already established, ideation can start immediately on features. 3) Focus idea generation on specific jobs and desired outcomes.

While the value delivery platform is abbreviated to “platform” in this paper, it should be noted that a value delivery platform data structure is new term. It is intended to represent a system infrastructure and subsystems that deliver a core product or service function, enabling a customer to get a job of interest done. The value delivery platform is the system into which features will be integrated and the glue that holds those features in place. Thus, the term is not intended to simply refer to a product family platform (such as a frame for a family of automobiles).

The value delivery platform data structure may be designed for use with a product or a service. For a product, parameters include energy source, size, and shape. (Core mechanical, electrical, chemical and/or software components could be considered subsystems.) For a service, parameters include physical assets (e.g., buildings, trucks, etc.) and other resources (e.g., people, information, organizational structure, software, communication systems, etc.). In practice, the data structure should have sufficient parameters to explain how an available system infrastructure and subsystems enable a customer to get a job of interest done, but should not normally include all features needed to satisfy the customers desired outcomes.

In the example of FIG. 17, the flowchart 1700 continues to module 1704 with comparing the value delivery platform data structure with templates of existing value delivery platform data structures. One advantage of data structures is that specially programmed computers can make comparisons between them. Templates of existing platforms can suggest modularity. For example, if a platform size is reduced, then a platform weight is also frequently reduced. This forms a correlation between a first parameter modification and a second parameter modification that can be attempted first because of the experience learning that the first often goes with the second. Other jobs may not have correlations that are readily apparent, but by analyzing a plethora of templates, a correlation may emerge. Thus, certain metrics may form a theme or grouping, facilitating a segmentation of a market based upon scores associated with various parameters. This can be exceptionally valuable when efficiently generating a tool (described later with reference to the example of FIG. 17).

In the example of FIG. 17, the flowchart 1700 continues to module 1705 with using creativity triggers to modify the parameters of the value delivery platform data structure. Advantageously, since the platform is separate from the business model and features, changes to the platform are possible without impacting subsystems or the business model in use. Moreover, it becomes possible to automate the ideation process, resulting in specially programmed computers that can actually innovate without human assistance. In an implementation that includes human oversight, the specially programmed computer can apply creativity triggers to provide a desirable solution that a human need only consent to, or modify, after the specially programmed computer provides the innovation to the human. By comparing the innovation using templates of existing platforms, the innovation that resembles previously successful innovation efforts can “float to the top” or be given more weight, enabling rapid identification of good innovation.

To enable computer innovation, creativity triggers can be programmed in association with various data structure parameters. It should be noted that humans would also likely find the creativity triggers useful in attempting innovations related to the value delivery platform. A relatively comprehensive list of examples of creativity triggers are provided in Table 9.

TABLE 9
Creativity Triggers for Value Delivery Platforms

| | |
|---|---|
| 1. | Change the platform into another state of matter to get the |
| | job done |
| 2. | Make the platform virtual |
| 3. | Make the platform disposable |
| 4. | Create a new platform to execute a portion of a job that is |
| | performed inefficiently on the core platform |
| 5. | Make the platform out of a large number of small platforms |
| 6. | Make the platform modular so each step in the job can be |
| | optimized for performance |
| 7. | Remove platform infrastructure that is not needed to get the |
| | job done |
| 8. | Borrow available resources and make them part of the platform |
| 9. | Eliminate the wasting of consumables |
| 10. | Construct the platform so that consumables are eliminated |
| 11. | Make the platform customizable |
| 12. | Make one standardized platform |
| 13. | Reduce the size of the platform |
| 14. | Make the platform scalable |
| 15. | Construct the platform so that it allows third parties to add |
| | features or content over time |
| 16. | Make the platform capable of performing additional jobs |
| 17. | Make the platform automatically perform physical activities |
| 18. | Make the platform automatically perform decision-making |
| | activities |
| 19. | Make the platform identify and self-correct its mistakes |
| 20. | Hid platform infrastructure that does not have to be visible |
| 21. | Construct the platform so that it can perform the job at a |
| | different frequency |
| 22. | Construct the platform so that it can perform the job at |
| | different speeds |
| 23. | Construct the platform so that there is no downtime in the |
| | execution of the job |
| 24. | Reduce the weight of the platform |
| 25. | Construct the platform to eliminate all product life cycle issues |
| 26. | Make the platform energy efficient |

In the example of FIG. 17, the flowchart 1700 continues to module 1706 with providing a basic business model data structure. A specially programmed computer can make suggestions regarding a basic business model and predictions about profitability, based upon basic business model templates associated with value delivery platform templates that are in at least some way similar to the platform being considered.

In the example of FIG. 17, the flowchart 1700 continues to module 1708 with using creativity triggers to modify parameters of the basic business model data structure. Creativity triggers can be used to improve upon the basic business model. For example, a creativity trigger to “turn a waste into a revenue” could cause the specially purposed computer to consider the value of a byproduct of a process for sale to another entity, or perhaps for use in some other process. So a creativity trigger to “turn a cost into a revenue” may trigger a suggestion to charge a customer for sales calls based upon an at least similar in some respects basic business model template.

In the example of FIG. 17, the flowchart 1700 continues to module 1712 with applying features to the value delivery platform data structure. As used in this paper, a feature is a tangible or intangible that performs a function that allows customers to better satisfy a desired outcome. A feature can include, by way of example, a piece of information, an action, a component, a material, a part of a physical object, or the like. When features are integrated into the value delivery platform, the resultant data structure can be referred to as a “tool.” That is, a process or device that accomplishes or can be used to accomplish a job. Advantageously, the tool is virtual, but platform-level parameters and business model parameters are known, or at least predicted, for the tool before it is ever implemented or physically created. Moreover, in a system that includes competitor input, virtual tools of competitors can also be created and the differences understood before launching a product.

In the example of FIG. 17, the flowchart 1700 continues to module 1714 with providing an investment decision. Advantageously, by using the tool, high-quality investment decisions can be largely automated based upon comparisons with competitor tools and a database of successfully generated tools (platform templates).

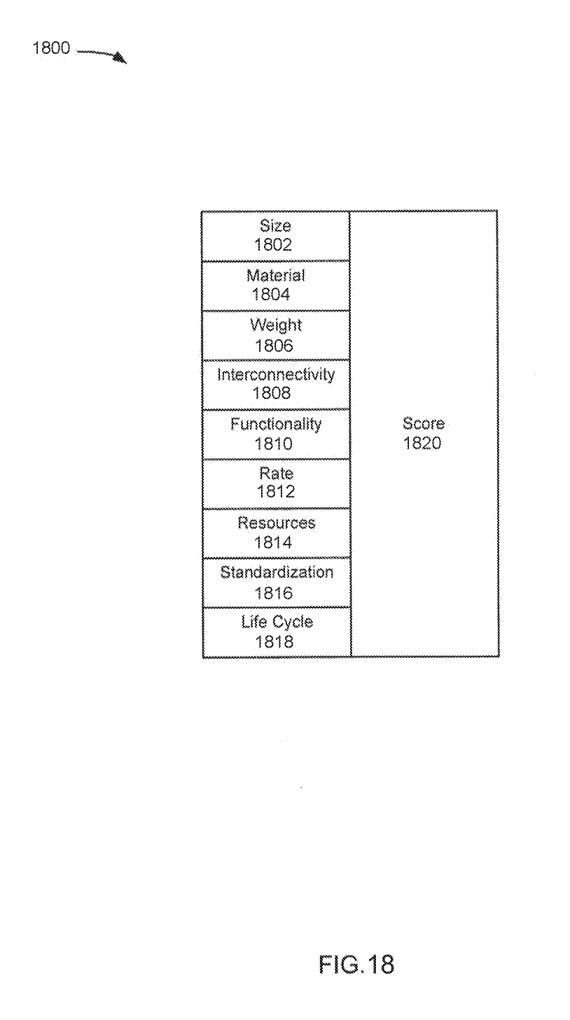

FIG. 18 depicts an example of a platform data structure 1800. The data structure 1800 includes a size parameter 1802. In an implementation where the platform is represented as an object, the size parameter 1802 can include a different value for each of a plurality of subcomponents that make up the platform. The greater the accuracy of the size parameter, the more effectively a platform innovation engine will be able to vary the size and evaluate the desirability of the variation. The platform innovation engine is well-suited to determining how changes in size will impact how the objects fit together geometrically. (If you change the size of a bolt, it will impact the size of a nut, for example.)

The data structure 1800 includes a material parameter 1804. In some cases, it may be desirable to change the platform into another state of matter (e.g., use a liquid or gas instead of a solid, use light waves instead of heat, etc.). In other cases, it may be desirable to virtualize certain portions of the platform (e.g., simulated, digital, etc.). In other cases, it may be desirable to use disposable materials. These various options require a relatively sophisticated description of material, rather than simply a relative number. In some cases, operating temperatures may be relevant to ensure that solids do not melt. So the greater the detail provided in the material parameter 1804, the better the platform innovation engine will be able to substitute values to provide meaningful results. As a simple example, consider a toothbrush as a platform. The handle may be constructed of plastic having a certain composition, springiness, hardness, smoothness, etc. If a parameter (say, springiness), is not listed, then the platform innovation engine will be unable to address a customer desire to have a springier handle. Other relatively straight-forward material data includes the cost of the material, and durability (lifetime). For a component to be made disposable, it would likely be desirable to reduce the durability to a proper range, and reduce the materials cost as well.

The data structure 1800 includes a weight parameter 1806. Although it is true that if a size and material is clearly defined, the weight can be derived, it is not always efficient to attempt to describe a material with such specificity as to make the weight of the object completely predicable. For certain objects having a size and material density, of course, weight could be derived. In some cases, it may be desirable to consider increasing weight by adding another component, such as a metal base, and it is probably a more effective use of resources to record the final weight (or even the weight of each component) rather than recomputed weight from size and material of each component each time.

The data structure 1800 includes an interconnectivity parameter 1808. As has been mentioned, a platform can comprise multiple components. The components can be modular, identical, opposite, independent, connected, etc. The interconnectivity parameter 1808 describes the connections of the various components. This can facilitate an analysis of how to create a new platform to execute a portion of the job that is performed inefficiently on an old platform, increase or decrease the number of components, or improve modularity or reuse redundant components. The interconnectivity parameter 1808 can also provide insight into how to attach components in a scalable fashion (“scalability”).

The data structure 1800 includes a functionality parameter 1810. The functionality parameter 1810 can describe a transformation of an input into an output. Some components do not have any transformational functionality however, such as a chassis that holds components together or a base that provides stability. The functionality can be relevant for determining how size, interconnectivity, and weight can be adjusted to improve the functionality. When determining whether a platform meets the requirements of a job, assuming the functionality parameter 1810 is sufficiently accurate, some components might be determined to be unnecessary. That is, some components might have other purposes (or not), but those purposes are not necessary for a particular job that is being considered. This can be useful to a platform innovation engine when suggesting to remove systems of subsystems from a platform. Also, knowing the functionality of other components can help suggest modification of the platform to allow the addition of features or content by third parties; make the platform capable of performing additional jobs, perhaps by redundantly using present functionality; and make the platform capable of automatically performing physical activities, decision-making activities, or self-correction. In many ways, this can be thought of as an interplay between the interconnectivity parameter 1808 and the functionality parameter 1810.

The data structure 1800 includes a rate parameter 1812. The rate parameter 1812 can be associated with frequency, speed, or downtime. Generally, frequency and speed might be better increased or decreased, while downtime is best minimized.

The data structure 1800 includes a resources parameter 1814. Resources can include resources available (energy, materials, information, dimensionality, waste, objects, people, etc.). If a resource can be used, then a platform innovation engine might tweak parameters to see if there is improvement. For example, if a widget can be increased in size without pushing against a casement, it might be desirable to decrease the size of the casement or increase the size of the widget. Resources can also include consumables, which perhaps can be reduced or eliminated, or the source of the consumables could be changed to take advantage of byproducts (waste) of another component or separate platform. Efficiency can even be improved by using a different power source or identifying use and perhaps shutting down when not in use.

The data structure 1800 includes a standardization parameter 1816. The flip side of standardization is customization. Defining how much of a component is standardized can facilitate determining what portions can be customized.

The data structure 1800 includes a life cycle parameter 1818. It is typically desirable to reduce or eliminate all product life cycle issues (e.g., packaging, installation, maintenance, storage, disposal, etc.). The more descriptive the data, the better a platform innovation engine will be able to identify potential improvements.

The data structure 1800 includes a score parameter 1820. The score parameter 1820 can be associated with one or more of the other parameters. Sometimes, depending upon the job, one or more of the parameters may be irrelevant in determining a score. It should be noted that the score parameters 1820 comprises a plurality of subscores derived from the satisfaction and value associated with various other parameter values, depending upon the job (see, e.g., FIG. 15).

Advantageously, where data structures have the same format, comparisons across data structures become informative. Additional parameters could be useful, but the parameters depicted in the example of FIG. 18 are intended to be relatively comprehensive.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Implementations can also relate to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present example is not described with reference to any particular programming language, and various examples may thus be implemented using a variety of programming languages.

What is claimed is:

1. A computer readable medium comprising multiple instructions executed in a predetermined sequence for creating a market growth strategy wherein the multiple instructions comprise the instructions of:
selecting a strategic market for the market growth strategy;
selecting customer job(s) in a customer chain to target; and
selecting consumption chain jobs to target
